(19) United States
(12) Patent Application Publication
(10) Pub. No.: US 2026/0342974 A1
(43) Pub. Date: Oct. 29, 2026

(54) METHOD, APPARATUS, AND MEDIUM FOR VIDEO PROCESSING

(71) Applicants: Beijing Bytedance Network Technology Co., Ltd., Beijing (CN); Bytedance Inc., Los Angeles, CA (US)

(72) Inventors: Yang WANG, Beijing (CN); Kai ZHANG, Los Angeles, CA (US); Li ZHANG, Los Angeles, CA (US)

(21) Appl. No.: 19/728,039

(22) Filed: Jul. 1, 2026

Related U.S. Application Data
(63) Continuation of application No. 18/438,013, filed on Feb. 9, 2024.
Application No. 18/438,013 is a continuation of application No. PCT/CN2022/111080, filed on Aug. 9, 2022.

(30) Foreign Application Priority Data
Aug. 11, 2021 (WO) PCT/CN2021/112156

(51) Int. Cl. H04N 19/11; H04N 19/105; H04N 19/159; H04N 19/186; H04N 19/196

(52) U.S. Cl. CPC H04N 19/11; H04N 19/105; H04N 19/159; H04N 19/186; H04N 19/196

(57) ABSTRACT

A method for video processing is proposed. The method comprises: deriving, during a conversion between a target unit of a video and a bitstream of the target unit, an intra prediction mode (IPM) of the target unit for at least one chroma component (2610), the target unit being applied with a target coding tool; obtaining a prediction of the target unit for the at least one chroma component using the IPM (2620); and performing the conversion based on the prediction of the target unit for the at least one chroma component (2630).

### CROSS REFERENCE

This application is a continuation of U.S. patent application Ser. No. 18/438,013 entitled “METHOD, APPARATUS, AND MEDIUM FOR VIDEO PROCESSING” filed on Feb. 9, 2024, which is a continuation of International Application No. PCT/CN2022/111080, filed on Aug. 9, 2022, which claims the benefit of International Application No. PCT/CN2021/112156 filed on Aug. 11, 2021. The entire contents of these applications are hereby incorporated by reference in their entireties.

### FIELD

Embodiments of the present disclosure relates generally to video coding techniques, and more particularly, to intra prediction mode derivation for chroma.

### BACKGROUND

In nowadays, digital video capabilities are being applied in various aspects of peoples' lives. Multiple types of video compression technologies, such as MPEG-2, MPEG-4, ITU-TH.263, ITU-TH.264/MPEG-4 Part 10 Advanced Video Coding (AVC), ITU-TH.265 high efficiency video coding (HEVC) standard, versatile video coding (VVC) standard, have been proposed for video encoding/decoding. However, coding efficiency of video coding techniques is generally expected to be further improved.

### SUMMARY

Embodiments of the present disclosure provide a solution for video processing.

In a first aspect, a method for video processing is proposed. The method comprises: deriving, during a conversion between a target unit of a video and a bitstream of the target unit, an intra prediction mode (IPM) for at least one chroma component of the target unit, the target unit being applied with a target coding tool; obtaining a prediction for the at least one chroma component of the target unit using the IPM; and performing the conversion based on the prediction. Compared with conventional technologies, coding efficiency and compression efficiency are improved.

In a second aspect, an apparatus for processing video data is proposed. The apparatus for processing video data comprising a processor and a non-transitory memory with instructions thereon, wherein the instructions upon execution by the processor, cause the processor to derive, during a conversion between a target unit of a video and a bitstream of the target unit, an intra prediction mode (IPM) for at least one chroma component of the target unit, the target unit being applied with a target coding tool; obtain a prediction for the at least one chroma component of the target unit using the IPM; and perform the conversion based on the prediction. Compared with conventional technologies, coding efficiency and compression efficiency are improved.

In a third aspect, a non-transitory computer-readable storage medium. The non-transitory computer-readable storage medium storing instructions that cause a processor to perform a method. The method comprises: deriving, during a conversion between a target unit of a video and a bitstream of the target unit, an intra prediction mode (IPM) for at least one chroma component of the target unit, the target unit being applied with a target coding tool; obtaining a prediction for the at least one chroma component of the target unit using the IPM; and performing the conversion based on the prediction o. Compared with conventional technologies, coding efficiency and compression efficiency are improved.

In a fourth aspect, a non-transitory computer-readable recording medium is proposed. The non-transitory computer-readable recording medium storing a bitstream of a video which is generated by a method performed by a video processing apparatus, wherein the method comprises: deriving an intra prediction mode (IPM) for at least one chroma component of a target unit of the video, the target unit being applied with a target coding tool; obtaining a prediction for the at least one chroma component of the target unit using the IPM; and generating a bitstream of the target unit based on the prediction.

In a fifth aspect, another method for video processing is proposed. The method for storing bitstream of a video, comprising: deriving an intra prediction mode (IPM) for at least one chroma component of a target unit of the video, the target unit being applied with a target coding tool; obtaining a prediction for the at least one chroma component of the target unit using the IPM; generating a bitstream of the target unit based on the prediction; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example video coding system, in accordance with some embodiments of the present disclosure;

FIG. 2 illustrates a block diagram that illustrates a first example video encoder, in accordance with some embodiments of the present disclosure;

FIG. 3 illustrates a block diagram that illustrates an example video decoder, in accordance with some embodiments of the present disclosure;

FIG. 4 illustrates nominal vertical and horizontal locations of 4:2:2 luma and chroma samples in a picture;

FIG. 5 illustrates an example of encoder block diagram;

FIG. 6 illustrates a schematic diagram of 67 intra prediction modes;

FIG. 7 illustrates reference samples for wide-angular intra prediction;

FIG. 8 illustrates a schematic diagram of problem of discontinuity in case of directions beyond 45°;

FIG. 9 illustrates a schematic diagram of locations of the samples used for the derivation of α and β;

FIG. 10 illustrates an example of classifying the neighboring samples into two groups;

FIGS. 11a-11d illustrate definition of samples used by PDPC applied to diagonal and adjacent angular intra modes, wherein FIG. 8a illustrates diagonal top-right mode, FIG. 8b illustrates diagonal bottom-left mode, FIG. 8c illustrates adjacent diagonal top-right mode, and FIG. 8d illustrates adjacent diagonal bottom-left mode;

FIG. 12 illustrates gradient approach for non-vertical/non-horizontal mode;

FIG. 13 illustrates nScale values with respect to nTbH and mode number; for all nScale<0 cases gradient approach is used;

FIG. 14 illustrates flowchart: current PDPC (left), and proposed PDPC (right);

FIG. 15 illustrates neighbouring blocks (L, A, BL, AR, AL) used in the derivation of a general MPM list;

FIG. 16 illustrates an example on proposed intra reference mapping;

FIG. 17 illustrates an example of four reference lines neighbouring to a prediction block;

FIG. 18 illustrates a schematic diagram of sub-partition depending on the block size;

FIG. 19 illustrates matrix weighted intra prediction process;

FIG. 20 illustrates target samples, template samples and the reference samples of template used in the DIMD. For each intra prediction mode, the DIMD calculates the absolute difference (SAD) between the reconstructed template samples and its prediction samples obtained from the reference samples of the template. The intra prediction mode that yields the minimum SAD is selected as the final intra prediction mode of the target unit;

FIG. 21 illustrates the proposed intra block decoding process;

FIG. 22 illustrates HoG computation from a template of width 3 pixels;

FIG. 23 illustrates prediction fusion by weighted averaging of two HoG modes and planar;

FIG. 24 illustrates conventional angular IPMs (denoted by arrows) and extended angular IPMs (denoted by dashed lines);

FIGS. 25a-25j illustrate templates used in the derivation of IPM for Chroma, respectively;

FIG. 26 illustrates a flow chart of a method according to embodiments of the present disclosure; and

FIG. 27 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

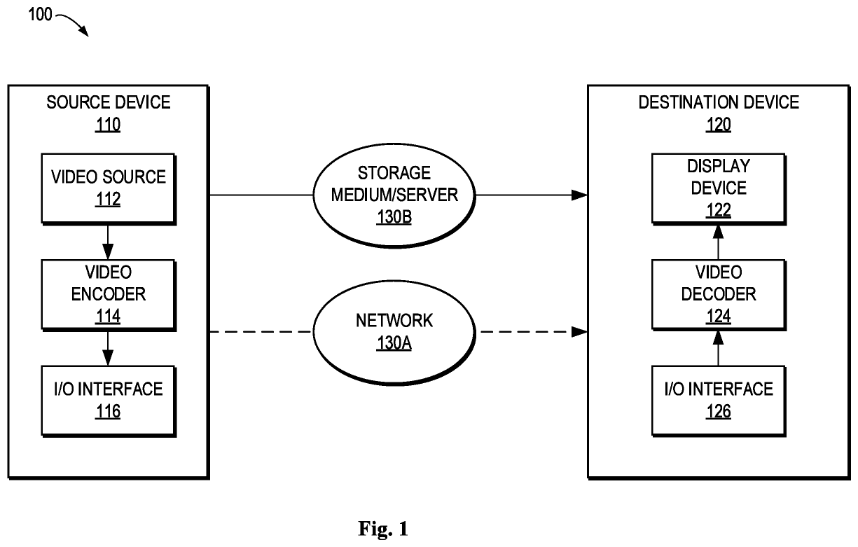

FIG. 1 is a block diagram that illustrates an example video coding system 100 that may utilize the techniques of this disclosure. As shown, the video coding system 100 may include a source device 110 and a destination device 120. The source device 110 can be also referred to as a video encoding device, and the destination device 120 can be also referred to as a video decoding device. In operation, the source device 110 can be configured to generate encoded video data and the destination device 120 can be configured to decode the encoded video data generated by the source device 110. The source device 110 may include a video source 112, a video encoder 114, and an input/output (I/O) interface 116.

The video source 112 may include a source such as a video capture device. Examples of the video capture device include, but are not limited to, an interface to receive video data from a video content provider, a computer graphics system for generating video data, and/or a combination thereof.

The video data may comprise one or more pictures. The video encoder 114 encodes the video data from the video source 112 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. The I/O interface 116 may include a modulator/demodulator and/or a transmitter. The encoded video data may be transmitted directly to destination device 120 via the I/O interface 116 through the network 130A. The encoded video data may also be stored onto a storage medium/server 130B for access by destination device 120.

The destination device 120 may include an I/O interface 126, a video decoder 124, and a display device 122. The I/O interface 126 may include a receiver and/or a modem. The I/O interface 126 may acquire encoded video data from the source device 110 or the storage medium/server 130B. The video decoder 124 may decode the encoded video data. The display device 122 may display the decoded video data to a user. The display device 122 may be integrated with the destination device 120, or may be external to the destination device 120 which is configured to interface with an external display device.

The video encoder 114 and the video decoder 124 may operate according to a video compression standard, such as the High Efficiency Video Coding (HEVC) standard, Versatile Video Coding (VVC) standard and other current and/or further standards.

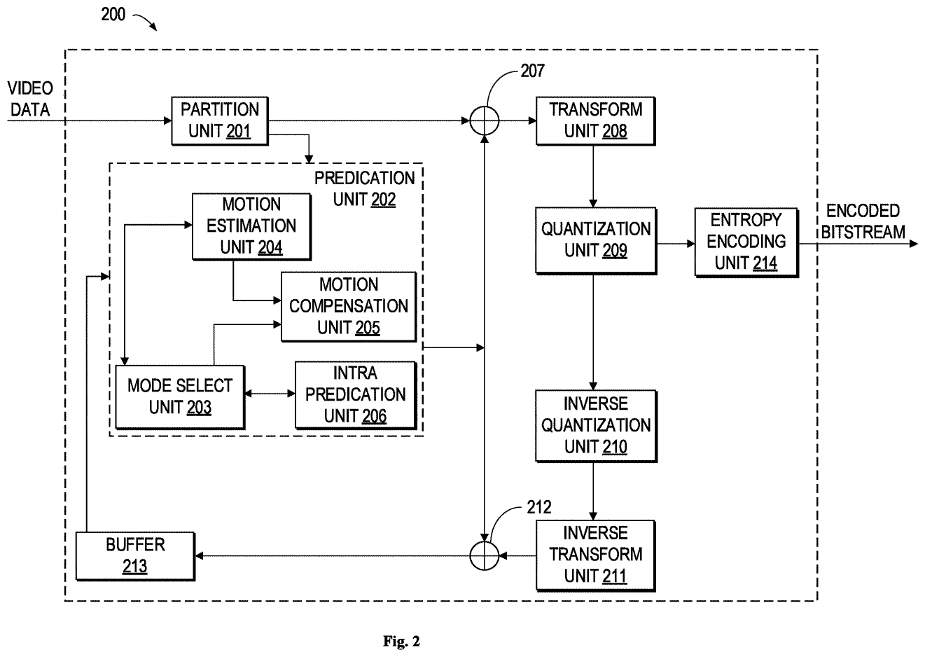

FIG. 2 is a block diagram illustrating an example of a video encoder 200, which may be an example of the video encoder 114 in the system 100 illustrated in FIG. 1, in accordance with some embodiments of the present disclosure.

The video encoder 200 may be configured to implement any or all of the techniques of this disclosure. In the example of FIG. 2, the video encoder 200 includes a plurality of functional components. The techniques described in this disclosure may be shared among the various components of the video encoder 200. In some examples, a processor may be configured to perform any or all of the techniques described in this disclosure.

In some embodiments, the video encoder 200 may include a partition unit 201, a predication unit 202 which may include a mode select unit 203, a motion estimation unit 204, a motion compensation unit 205 and an intra-prediction unit 206, a residual generation unit 207, a transform unit 208, a quantization unit 209, an inverse quantization unit 210, an inverse transform unit 211, a reconstruction unit 212, a buffer 213, and an entropy encoding unit 214.

In other examples, the video encoder 200 may include more, fewer, or different functional components. In an example, the predication unit 202 may include an intra block copy (IBC) unit. The IBC unit may perform predication in an IBC mode in which at least one reference picture is a picture where the current video block is located.

Furthermore, although some components, such as the motion estimation unit 204 and the motion compensation unit 205, may be integrated, but are represented in the example of FIG. 2 separately for purposes of explanation.

The partition unit 201 may partition a picture into one or more video blocks. The video encoder 200 and the video decoder 300 may support various video block sizes.

The mode select unit 203 may select one of the coding modes, intra or inter, e.g., based on error results, and provide the resulting intra-coded or inter-coded block to a residual generation unit 207 to generate residual block data and to a reconstruction unit 212 to reconstruct the encoded block for use as a reference picture. In some examples, the mode select unit 203 may select a combination of intra and inter predication (CIIP) mode in which the predication is based on an inter predication signal and an intra predication signal. The mode select unit 203 may also select a resolution for a motion vector (e.g., a sub-pixel or integer pixel precision) for the block in the case of inter-predication.

To perform inter prediction on a current video block, the motion estimation unit 204 may generate motion information for the current video block by comparing one or more reference frames from buffer 213 to the current video block. The motion compensation unit 205 may determine a predicted video block for the current video block based on the motion information and decoded samples of pictures from the buffer 213 other than the picture associated with the current video block.

The motion estimation unit 204 and the motion compensation unit 205 may perform different operations for a current video block, for example, depending on whether the current video block is in an I-slice, a P-slice, or a B-slice. As used herein, an “I-slice” may refer to a portion of a picture composed of macroblocks, all of which are based upon macroblocks within the same picture. Further, as used herein, in some aspects, “P-slices” and “B-slices” may refer to portions of a picture composed of macroblocks that are not dependent on macroblocks in the same picture.

In some examples, the motion estimation unit 204 may perform uni-directional prediction for the current video block, and the motion estimation unit 204 may search reference pictures of list 0 or list 1 for a reference video block for the current video block. The motion estimation unit 204 may then generate a reference index that indicates the reference picture in list 0 or list 1 that contains the reference video block and a motion vector that indicates a spatial displacement between the current video block and the reference video block. The motion estimation unit 204 may output the reference index, a prediction direction indicator, and the motion vector as the motion information of the current video block. The motion compensation unit 205 may generate the predicted video block of the current video block based on the reference video block indicated by the motion information of the current video block.

Alternatively, in other examples, the motion estimation unit 204 may perform bi-directional prediction for the current video block. The motion estimation unit 204 may search the reference pictures in list 0 for a reference video block for the current video block and may also search the reference pictures in list 1 for another reference video block for the current video block. The motion estimation unit 204 may then generate reference indexes that indicate the reference pictures in list 0 and list 1 containing the reference video blocks and motion vectors that indicate spatial displacements between the reference video blocks and the current video block. The motion estimation unit 204 may output the reference indexes and the motion vectors of the current video block as the motion information of the current video block. The motion compensation unit 205 may generate the predicted video block of the current video block based on the reference video blocks indicated by the motion information of the current video block.

In some examples, the motion estimation unit 204 may output a full set of motion information for decoding processing of a decoder. Alternatively, in some embodiments, the motion estimation unit 204 may signal the motion information of the current video block with reference to the motion information of another video block. For example, the motion estimation unit 204 may determine that the motion information of the current video block is sufficiently similar to the motion information of a neighboring video block.

In one example, the motion estimation unit 204 may indicate, in a syntax structure associated with the current video block, a value that indicates to the video decoder 300 that the current video block has the same motion information as the another video block.

In another example, the motion estimation unit 204 may identify, in a syntax structure associated with the current video block, another video block and a motion vector difference (MVD). The motion vector difference indicates a difference between the motion vector of the current video block and the motion vector of the indicated video block. The video decoder 300 may use the motion vector of the indicated video block and the motion vector difference to determine the motion vector of the current video block.

As discussed above, video encoder 200 may predictively signal the motion vector. Two examples of predictive signaling techniques that may be implemented by video encoder 200 include advanced motion vector predication (AMVP) and merge mode signaling.

The intra prediction unit 206 may perform intra prediction on the current video block. When the intra prediction unit 206 performs intra prediction on the current video block, the intra prediction unit 206 may generate prediction data for the current video block based on decoded samples of other video blocks in the same picture. The prediction data for the current video block may include a predicted video block and various syntax elements.

The residual generation unit 207 may generate residual data for the current video block by subtracting (e.g., indicated by the minus sign) the predicted video block(s) of the current video block from the current video block. The residual data of the current video block may include residual video blocks that correspond to different sample components of the samples in the current video block.

In other examples, there may be no residual data for the current video block for the current video block, for example in a skip mode, and the residual generation unit 207 may not perform the subtracting operation.

The transform processing unit 208 may generate one or more transform coefficient video blocks for the current video block by applying one or more transforms to a residual video block associated with the current video block.

After the transform processing unit 208 generates a transform coefficient video block associated with the current video block, the quantization unit 209 may quantize the transform coefficient video block associated with the current video block based on one or more quantization parameter (QP) values associated with the current video block.

The inverse quantization unit 210 and the inverse transform unit 211 may apply inverse quantization and inverse transforms to the transform coefficient video block, respectively, to reconstruct a residual video block from the transform coefficient video block. The reconstruction unit 212 may add the reconstructed residual video block to corresponding samples from one or more predicted video blocks generated by the predication unit 202 to produce a reconstructed video block associated with the current video block for storage in the buffer 213.

After the reconstruction unit 212 reconstructs the video block, loop filtering operation may be performed to reduce video blocking artifacts in the video block.

The entropy encoding unit 214 may receive data from other functional components of the video encoder 200. When the entropy encoding unit 214 receives the data, the entropy encoding unit 214 may perform one or more entropy encoding operations to generate entropy encoded data and output a bitstream that includes the entropy encoded data.

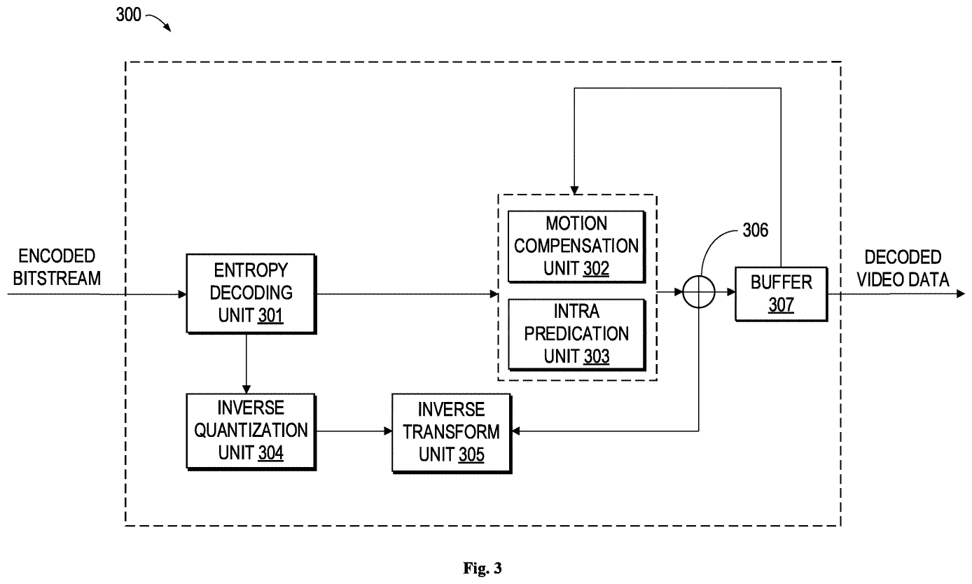

FIG. 3 is a block diagram illustrating an example of a video decoder 300, which may be an example of the video decoder 124 in the system 100 illustrated in FIG. 1, in accordance with some embodiments of the present disclosure.

The video decoder 300 may be configured to perform any or all of the techniques of this disclosure. In the example of FIG. 3, the video decoder 300 includes a plurality of functional components. The techniques described in this disclosure may be shared among the various components of the video decoder 300. In some examples, a processor may be configured to perform any or all of the techniques described in this disclosure.

In the example of FIG. 3, the video decoder 300 includes an entropy decoding unit 301, a motion compensation unit 302, an intra prediction unit 303, an inverse quantization unit 304, an inverse transformation unit 305, and a reconstruction unit 306 and a buffer 307. The video decoder 300 may, in some examples, perform a decoding pass generally reciprocal to the encoding pass described with respect to video encoder 200.

The entropy decoding unit 301 may retrieve an encoded bitstream. The encoded bitstream may include entropy coded video data (e.g., encoded blocks of video data). The entropy decoding unit 301 may decode the entropy coded video data, and from the entropy decoded video data, the motion compensation unit 302 may determine motion information including motion vectors, motion vector precision, reference picture list indexes, and other motion information. The motion compensation unit 302 may, for example, determine such information by performing the AMVP and merge mode. AMVP is used, including derivation of several most probable candidates based on data from adjacent PBs and the reference picture. Motion information typically includes the horizontal and vertical motion vector displacement values, one or two reference picture indices, and, in the case of prediction regions in B slices, an identification of which reference picture list is associated with each index. As used herein, in some aspects, a “merge mode” may refer to deriving the motion information from spatially or temporally neighboring blocks.

The motion compensation unit 302 may produce motion compensated blocks, possibly performing interpolation based on interpolation filters. Identifiers for interpolation filters to be used with sub-pixel precision may be included in the syntax elements.

The motion compensation unit 302 may use the interpolation filters as used by the video encoder 200 during encoding of the video block to calculate interpolated values for sub-integer pixels of a reference block. The motion compensation unit 302 may determine the interpolation filters used by the video encoder 200 according to the received syntax information and use the interpolation filters to produce predictive blocks.

The motion compensation unit 302 may use at least part of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter-encoded block, and other information to decode the encoded video sequence. As used herein, in some aspects, a “slice” may refer to a data structure that can be decoded independently from other slices of the same picture, in terms of entropy coding, signal prediction, and residual signal reconstruction. A slice can either be an entire picture or a region of a picture.

The intra prediction unit 303 may use intra prediction modes for example received in the bitstream to form a prediction block from spatially adjacent blocks. The inverse quantization unit 304 inverse quantizes, i.e., de-quantizes, the quantized video block coefficients provided in the bitstream and decoded by entropy decoding unit 301. The inverse transform unit 305 applies an inverse transform.

The reconstruction unit 306 may obtain the decoded blocks, e.g., by summing the residual blocks with the corresponding prediction blocks generated by the motion compensation unit 302 or intra-prediction unit 303. If desired, a deblocking filter may also be applied to filter the decoded blocks in order to remove blockiness artifacts. The decoded video blocks are then stored in the buffer 307, which provides reference blocks for subsequent motion compensation/intra predication and also produces decoded video for presentation on a display device.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to Versatile Video Coding or other specific video codecs, the disclosed techniques are applicable to other video coding technologies also. Furthermore, while some embodiments describe video coding steps in detail, it will be understood that corresponding steps decoding that undo the coding will be implemented by a decoder. Furthermore, the term video processing encompasses video coding or compression, video decoding or decompression and video transcoding in which video pixels are represented from one compressed format into another compressed format or at a different compressed bitrate.

### 1. SUMMARY

This present disclosure is related to video coding technologies. Specifically, it is related a coding tool that derives intra prediction mode of chroma components using previously decoded blocks, and coding of intra prediction mode for chroma components and other coding tools in image/video coding. It may be applied to the existing video coding standard like HEVC, or Versatile Video Coding (VVC). It may be also applicable to future video coding standards or video codec.

### 2. BACKGROUND

Video coding standards have evolved primarily through the development of the well-known ITU-T and ISO/IEC standards. The ITU-T produced H.261 and H.263, ISO/IEC produced MPEG-1 and MPEG-4 Visual, and the two organizations jointly produced the H.262/MPEG-2 Video and H.264/MPEG-4 Advanced Video Coding (AVC) and H.265/HEVC standards. Since H.262, the video coding standards are based on the hybrid video coding structure wherein temporal prediction plus transform coding are utilized. To explore the future video coding technologies beyond HEVC, Joint Video Exploration Team (JVET) was founded by VCEG and MPEG jointly in 2015. Since then, many new methods have been adopted by JVET and put into the reference software named Joint Exploration Model (JEM). In April 2018, the Joint Video Expert Team (JVET) between VCEG (Q6/16) and ISO/IEC JTC1 SC29/WG11 (MPEG) was created to work on the VVC standard targeting at 50% bitrate reduction compared to HEVC.

The latest version of VVC draft, i.e., Versatile Video Coding (Draft 10) could be found at: http://phenix.it-sudparis.eu/jvet/doc_end_user/documents/20_Teleconference/wg11/JVET-T2001-v1.zip The latest reference software of VVC, named VTM, could be found at:

https://vcgit.hhi.fraunhofer.de/jvet/VVCSoftware_VTM/-/tags/VTM-11.0

### 2.1. Color Space and Chroma Subsampling

Color space, also known as the color model (or color system), is an abstract mathematical model which simply describes the range of colors as tuples of numbers, typically as 3 or 4 values or color components (e.g. RGB). Basically speaking, color space is an elaboration of the coordinate system and sub-space.

For video compression, the most frequently used color spaces are YCbCr and RGB.

YCbCr, Y′CbCr, or Y Pb/Cb Pr/Cr, also written as YCBCR or Y′CBCR, is a family of color spaces used as a part of the color image pipeline in video and digital photography systems. Y′ is the luma component and CB and CR are the blue-difference and red-difference chroma components. Y′ (with prime) is distinguished from Y, which is luminance, meaning that light intensity is nonlinearly encoded based on gamma corrected RGB primaries.

Chroma subsampling is the practice of encoding images by implementing less resolution for chroma information than for luma information, taking advantage of the human visual system's lower acuity for color differences than for luminance.

2.1.1. 4:4:4

Each of the three Y′CbCr components have the same sample rate, thus there is no chroma subsampling. This scheme is sometimes used in high-end film scanners and cinematic post production.

2.1.2. 4:2:2

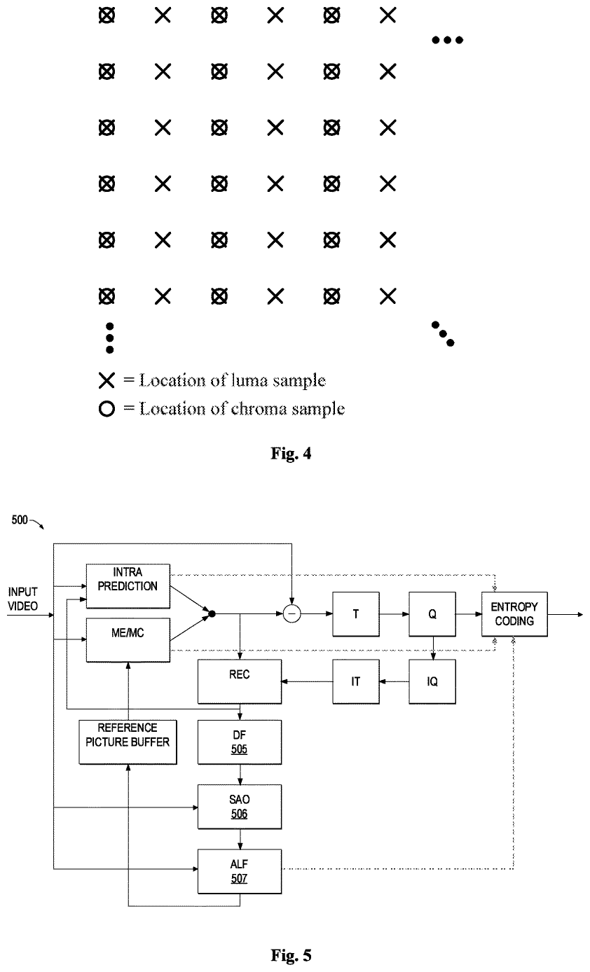

The two chroma components are sampled at half the sample rate of luma: the horizontal chroma resolution is halved while the vertical chroma resolution is unchanged. This reduces the bandwidth of an uncompressed video signal by one-third with little to no visual difference. An example of nominal vertical and horizontal locations of 4:2:2 color format is depicted in FIG. 4 in VVC working draft.

2.1.3. 4:2:0

In 4:2:0, the horizontal sampling is doubled compared to 4:1:1, but as the Cb and Cr channels are only sampled on each alternate line in this scheme, the vertical resolution is halved. The data rate is thus the same. Cb and Cr are each subsampled at a factor of 2 both horizontally and vertically. There are three variants of 4:2:0 schemes, having different horizontal and vertical siting.
┐ In MPEG-2, Cb and Cr are cosited horizontally. Cb and Cr are sited between pixels in the vertical direction (sited interstitially).
⊐ In JPEG/JFIF, H.261, and MPEG-1, Cb and Cr are sited interstitially, halfway between alternate luma samples.
   | In 4:2:0 DV, Cb and Cr are co-sited in the horizontal direction. In the vertical direction, they are co-sited on alternating lines.

TABLE 2-1
SubWidthC and SubHeightC values derived from chroma_
format_idc and separate_colour_plane_flag

| | | Chroma | | |
|---|---|---|---|---|
| chroma_format_idc | separate_colour_plane_flag | format | SubWidthC | SubHeightC |
| 0 | 0 | Monochrome | 1 | 1 |
| 1 | 0 | 4:2:0 | 2 | 2 |
| 2 | 0 | 4:2:2 | 2 | 1 |
| 3 | 0 | 4:4:4 | 1 | 1 |
| 3 | 1 | 4:4:4 | 1 | 1 |

### 2.2. Coding Flow of a Typical Video Codec

FIG. 5 shows an example of encoder block diagram 500 of VVC, which contains three in-loop filtering blocks: deblocking filter (DF) 505, sample adaptive offset (SAO) 506 and ALF 507. Unlike DF 505, which uses predefined filters, SAO 506 and ALF 507 utilize the original samples of the current picture to reduce the mean square errors between the original samples and the reconstructed samples by adding an offset and by applying a finite impulse response (FIR) filter, respectively, with coded side information signalling the offsets and filter coefficients. ALF is located at the last processing stage of each picture and can be regarded as a tool trying to catch and fix artifacts created by the previous stages.

2.3. Intra Mode Coding with 67 Intra Prediction Modes

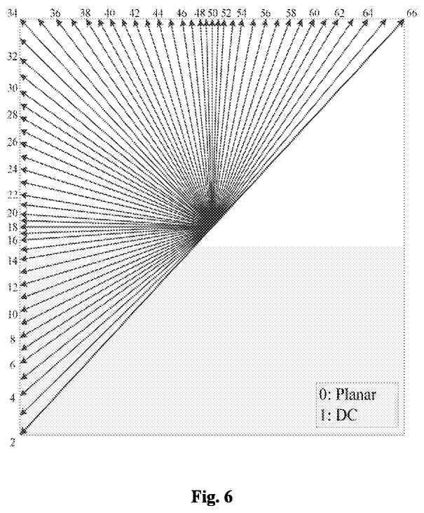

To capture the arbitrary edge directions presented in natural video, the number of directional intra modes is extended from 33, as used in HEVC, to 65, as shown in FIG. 6, and the planar and DC modes remain the same. These denser directional intra prediction modes apply for all block sizes and for both luma and chroma intra predictions.

In the HEVC, every intra-coded block has a square shape and the length of each of its side is a power of 2. Thus, no division operations are required to generate an intra-predictor using DC mode. In VVC, blocks can have a rectangular shape that necessitates the use of a division operation per block in the general case. To avoid division operations for DC prediction, only the longer side is used to compute the average for non-square blocks.

### 2.3.1. Wide Angle Intra Prediction

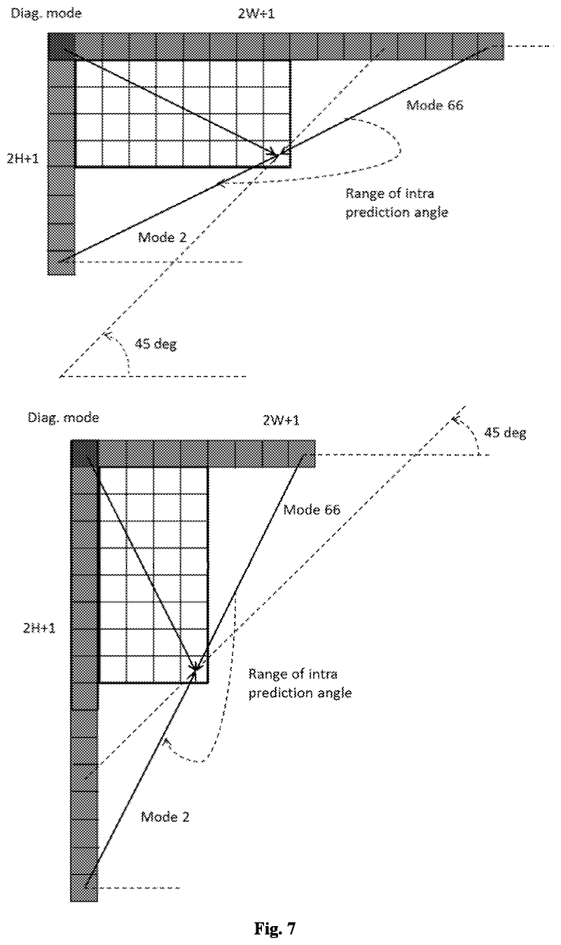

Although 67 modes are defined in the VVC, the exact prediction direction for a given intra prediction mode index is further dependent on the block shape. Conventional angular intra prediction directions are defined from 45 degrees to −135 degrees in clockwise direction. In VVC, several conventional angular intra prediction modes are adaptively replaced with wide-angle intra prediction modes for non-square blocks. The replaced modes are signalled using the original mode indexes, which are remapped to the indexes of wide angular modes after parsing. The total number of intra prediction modes is unchanged, i.e., 67, and the intra mode coding method is unchanged. To support these prediction directions, the top reference with length 2W+1, and the left reference with length 2H+1, are defined as shown in FIG. 7.

The number of replaced modes in wide-angular direction mode depends on the aspect ratio of a block. The replaced intra prediction modes are illustrated in Table 2-2

TABLE 2-2
Intra prediction modes replaced by wide-angular modes

| Aspect ratio | Replaced intra prediction modes |
|---|---|
| W/H == 16 | Modes 2, 3, 4, 5, 6, 7, 8, 9, 10, 11, 12, 13, 14, 15 |
| W/H == 8 | Modes 2, 3, 4, 5, 6, 7, 8, 9, 10, 11, 12, 13 |
| W/H == 4 | Modes 2, 3, 4, 5, 6, 7, 8, 9, 10, 11 |
| W/H == 2 | Modes 2, 3, 4, 5, 6, 7, 8, 9 |
| W/H == 1 | None |
| W/H == ½ | Modes 59, 60, 61, 62, 63, 64, 65, 66 |
| W/H == ¼ | Mode 57, 58, 59, 60, 61, 62, 63, 64, 65, 66 |
| W/H == ⅛ | Modes 55, 56, 57, 58, 59, 60, 61, 62, 63, 64, 65, 66 |
| W/H == 1/16 | Modes 53, 54, 55, 56, 57, 58, 59, 60, 61, 62, 63, 64, 65, |
| | 66 |

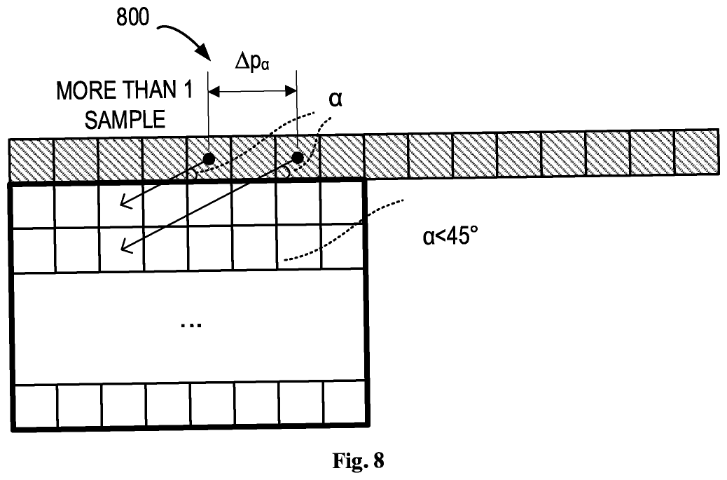

FIG. 8 illustrates a block diagram 800 of discontinuity in case of directions beyond 45 degree. As shown in FIG. 8, two vertically adjacent predicted samples may use two non-adjacent reference samples in the case of wide-angle intra prediction. Hence, low-pass reference samples filter and side smoothing are applied to the wide-angle prediction to reduce the negative effect of the increased gap Δp_{α}. If a wide-angle mode represents a non-fractional offset. There are 8 modes in the wide-angle modes satisfy this condition, which are [−14, −12, −10, −6, 72, 76, 78, 80]. When a block is predicted by these modes, the samples in the reference buffer are directly copied without applying any interpolation. With this modification, the number of samples needed to be smoothing is reduced. Besides, it aligns the design of non-fractional modes in the conventional prediction modes and wide-angle modes. In VVC, 4:2:2 and 4:4:4 chroma formats are supported as well as 4:2:0. Chroma derived mode (DM) derivation table for 4:2:2 chroma format was initially ported from HEVC extending the number of entries from 35 to 67 to align with the extension of intra prediction modes. Since HEVC specification does not support prediction angle below −135 degree and above 45 degree, luma intra prediction modes ranging from 2 to 5 are mapped to 2. Therefore, chroma DM derivation table for 4:2:2: chroma format is updated by replacing some values of the entries of the mapping table to convert prediction angle more precisely for chroma blocks.

### 2.4. Intra Prediction Mode Coding for Chroma Component

For the chroma component of an intra PU, the encoder selects the best chroma prediction modes among five modes including Planar, DC, Horizontal, Vertical and a direct copy of the intra prediction mode for the luma component. The mapping between intra prediction direction and intra prediction mode number for chroma is shown in Table 2-3.

When the intra prediction mode number for the chroma component is 4, the intra prediction direction for the luma component is used for the intra prediction sample generation for the chroma component. When the intra prediction mode number for the chroma component is not 4 and it is identical to the intra prediction mode number for the luma component, the intra prediction direction of 66 is used for the intra prediction sample generation for the chroma component.

### 2.5. Inter Prediction

For each inter-predicted CU, motion parameters consisting of motion vectors, reference picture indices and reference picture list usage index, and additional information needed for the new coding feature of VVC to be used for inter-predicted sample generation. The motion parameter can be signalled in an explicit or implicit manner. When a CU is coded with skip mode, the CU is associated with one PU and has no significant residual coefficients, no coded motion vector delta or reference picture index. A merge mode is specified whereby the motion parameters for the current CU are obtained from neighbouring CUs, including spatial and temporal candidates, and additional schedules introduced in VVC. The merge mode can be applied to any inter-predicted CU, not only for skip mode. The alternative to merge mode is the explicit transmission of motion parameters, where motion vector, corresponding reference picture index for each reference picture list and reference picture list usage flag and other needed information are signalled explicitly per each CU.

### 2.6. Intra Block Copy (IBC)

Intra block copy (IBC) is a tool adopted in HEVC extensions on SCC. It is well known that it significantly improves the coding efficiency of screen content materials. Since IBC mode is implemented as a block level coding mode, block matching (BM) is performed at the encoder to find the optimal block vector (or motion vector) for each CU. Here, a block vector is used to indicate the displacement from the current block to a reference block, which is already reconstructed inside the current picture. The luma block vector of an IBC-coded CU is in integer precision. The chroma block vector rounds to integer precision as well. When combined with AMVR, the IBC mode can switch between 1-pel and 4-pel motion vector precisions. An IBC-coded CU is treated as the third prediction mode other than intra or inter prediction modes. The IBC mode is applicable to the CUs with both width and height smaller than or equal to 64 luma samples.

At the encoder side, hash-based motion estimation is performed for IBC. The encoder performs RD check for blocks with either width or height no larger than 16 luma samples. For non-merge mode, the block vector search is performed using hash-based search first. If hash search does not return valid candidate, block matching based local search will be performed.

In the hash-based search, hash key matching (32-bit CRC) between the current block and a reference block is extended to all allowed block sizes. The hash key calculation for every position in the current picture is based on 4×4 sub-blocks. For the current block of a larger size, a hash key is determined to match that of the reference block when all the hash keys of all 4×4 sub-blocks match the hash keys in the corresponding reference locations. If hash keys of multiple reference blocks are found to match that of the current block, the block vector costs of each matched reference are calculated and the one with the minimum cost is selected.

In block matching search, the search range is set to cover both the previous and current CTUs.

At CU level, IBC mode is signalled with a flag and it can be signalled as IBC AMVP mode or IBC skip/merge mode as follows:
IBC skip/merge mode: a merge candidate index is used to indicate which of the block vectors in the list from neighbouring candidate IBC coded blocks is used to predict the current block. The merge list consists of spatial, HMVP, and pairwise candidates.
IBC AMVP mode: block vector difference is coded in the same way as a motion vector difference. The block vector prediction method uses two candidates as predictors, one from left neighbour and one from above neighbour (if IBC coded). When either neighbour is not available, a default block vector will be used as a predictor. A flag is signalled to indicate the block vector predictor index.

### 2.7. Cross-Component Linear Model Prediction

To reduce the cross-component redundancy, a cross-component linear model (CCLM) prediction mode is used in the VVC, for which the chroma samples are predicted based on the reconstructed luma samples of the same CU by using a linear model as follows:

pred_{C}(i,j)=α·rec_{L}′(i,j)+β (2-1)

where pred_{C}(i, j) represents the predicted chroma samples in a CU and rec_{L}(i, j) represents the down-sampled reconstructed luma samples of the same CU.

The CCLM parameters (α and β) are derived with at most four neighbouring chroma samples and their corresponding down-sampled luma samples. Suppose the current chroma block dimensions are W×H, then W″ and H′ are set as
W′=W, H′=H when LM mode is applied;
W′=W+H when LM_T mode is applied;
H′=H+W when LM_L mode is applied;

The above neighbouring positions are denoted as S[0,−1] . . . . S[W′−1,−1] and the left neighbouring positions are denoted as S[−1, 0] . . . . S[−1, H′−1]. Then the four samples are selected as
S[W′/4,−1], S[3*W′/4,−1], S[−1, H′/4], S[−1, 3*H′/4] when LM mode is applied and both above and left neighbouring samples are available;
S [W′/8,−1], S[3*W′/8,−1], S[5*W′/8,−1], S[7*W′/8,−1] when LM_T mode is applied or only the above neighbouring samples are available;
S [−1, H′/8], S[−1, 3*H′/8], S[−1, 5*H′/8], S[−1, 7*H′/8] when LM_L mode is applied or only the left neighbouring samples are available;

The four neighbouring luma samples at the selected positions are down-sampled and compared four times to find two larger values: x⁰_{A} and x¹_{A}, and two smaller values: x⁰_{B} and x¹_{B}. Their corresponding chroma sample values are denoted as y⁰_{A}, y¹_{A}, y⁰_{B} and y¹_{B}. Then x_{A}, x_{B}, y_{A} and y_{B} are derived as:

X_{α}=(x⁰_{A}+x¹_{A}+1)>1;X_{b}=(x⁰_{B}+x¹_{B}+1)>>1;Y_{α}=(y⁰_{A}+y¹_{A}+1)>1;Y_{b}=(y⁰_{B}+y¹B+1)>1 (2-2)

Finally, the linear model parameters α and β are obtained according to the following equations.

$$α = \frac{{Y}_{a} - {Y}_{b}}{{X}_{a} - {X}_{b}} \qquad ( 2 ‐ 3 )$$

$$β = {Y}_{b} - α \cdot {X}_{b} \qquad ( 2 ‐ 4 )$$

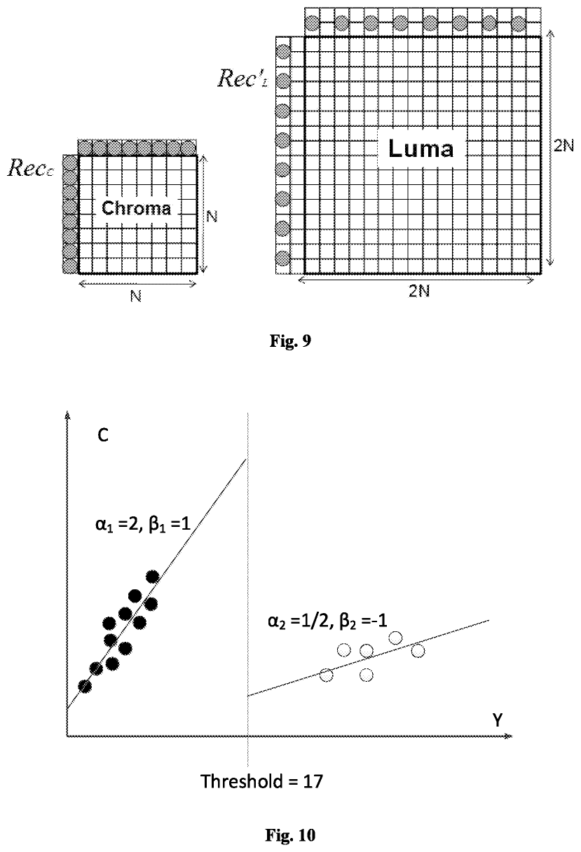

FIG. 9 shows an example of the location of the left and above samples and the sample of the current block involved in the CCLM mode.

The division operation to calculate parameter a is implemented with a look-up table. To reduce the memory required for storing the table, the diff value (difference between maximum and minimum values) and the parameter a are expressed by an exponential notation. For example, diff is approximated with a 4-bit significant part and an exponent. Consequently, the table for 1/diff is reduced into 16 elements for 16 values of the significand as follows:

DivTable[ ]={0,7,6,5,5,4,4,3,3,2,2,1,1,1,1,0} (2-5)

This would have a benefit of both reducing the complexity of the calculation as well as the memory size required for storing the needed tables

Besides the above template and left template can be used to calculate the linear model coefficients together, they also can be used alternatively in the other 2 LM modes, called LM_T, and LM_L modes.

In LM_T mode, only the above template is used to calculate the linear model coefficients. To get more samples, the above template is extended to (W+H) samples. In LM_L mode, only left template is used to calculate the linear model coefficients. To get more samples, the left template is extended to (H+W) samples.

In LM mode, left and above templates are used to calculate the linear model coefficients.

To match the chroma sample locations for 4:2:0 video sequences, two types of down-sampling filter are applied to luma samples to achieve 2 to 1 down-sampling ratio in both horizontal and vertical directions. The selection of down-sampling filter is specified by a SPS level flag. The two down-sampling filters are as follows, which are corresponding to “type-0” and “type-2” content, respectively.

$${Rec}_{L}^{′} ( i , j ) = [ \begin{matrix}{rec}_{L} ( 2 i - 1 , 2 j - 1 ) + {rec}_{L} ( 2 i - 1 , 2 j - 1 ) + \\ {rec}_{L} ( 2 i + 1 , 2 j - 1 ) + {rec}_{L} ( 2 i - 1 , 2 j ) + \\ 2 \cdot {rec}_{L} ( 2 i , 2 j ) + {rec}_{L} ( 2 i + 1 , 2 j ) + 4\end{matrix} ] >> 3 \qquad ( 2 ‐ 6 )$$

$${rec}_{L}^{′} ( i , j ) = [ \begin{matrix}{rec}_{L} ( 2 i , 2 j - 1 + {rec}_{L} ( 2 i - 1 , 2 j ) + \\ 4 \cdot {rec}_{L} ( 2 i , 2 j ) + re c ( 2 i + 1 , 2 j ) + \\ {rec}_{L} ( 2 i , 2 j + 1 ) + 4\end{matrix} ] >> 3 \qquad ( 2 ‐ 7 )$$

Note that only one luma line (general line buffer in intra prediction) is used to make the down-sampled luma samples when the upper reference line is at the CTU boundary.

This parameter computation is performed as part of the decoding process, and is not just as an encoder search operation. As a result, no syntax is used to convey the α and β values to the decoder.

For chroma intra mode coding, a total of 8 intra modes are allowed for chroma intra mode coding. Those modes include five conventional intra modes and three cross-component linear model modes (LM, LM_T, and LM_L). Chroma mode signalling and derivation process are shown in Table 2-3. Chroma mode coding directly depends on the intra prediction mode of the corresponding luma block. Since separate block partitioning structure for luma and chroma components is enabled in I slices, one chroma block may correspond to multiple luma blocks. Therefore, for Chroma DM mode, the intra prediction mode of the corresponding luma block covering the center position of the current chroma block is directly inherited.

TABLE 2-3
Derivation of chroma prediction mode
from luma mode when CCLM is enabled

| | Corresponding luma intra prediction mode | | | | |
|---|---|---|---|---|---|
| Chroma prediction mode | 0 | 50 | 18 | 1 | X (0 <= X <= 66) |
| 0 | 66 | 0 | 0 | 0 | 0 |
| 1 | 50 | 66 | 50 | 50 | 50 |
| 2 | 18 | 18 | 66 | 18 | 18 |
| 3 | 1 | 1 | 1 | 66 | 1 |
| 4 | 0 | 50 | 18 | 1 | X |
| 5 | 81 | 81 | 81 | 81 | 81 |
| 6 | 82 | 82 | 82 | 82 | 82 |
| 7 | 83 | 83 | 83 | 83 | 83 |

A single binarization table is used regardless of the value of sps_cclm_enabled_flag as shown in Table 2-4.

TABLE 2-4
Unified binarization table for chroma prediction mode

| Value of | |
|---|---|
| intra_chroma_pred_mode | Bin string |
| 4 | 00 |
| 0 | 0100 |
| 1 | 0101 |
| 2 | 0110 |
| 3 | 0111 |
| 5 | 10 |
| 6 | 110 |
| 7 | 111 |

In Table 2-4, the first bin indicates whether it is regular (0) or LM modes (1). If it is LM mode, then the next bin indicates whether it is LM_CHROMA (0) or not. If it is not LM_CHROMA, next 1 bin indicates whether it is LM_L (0) or LM_T (1). For this case, when sps_cclm_enabled_flag is 0, the first bin of the binarization table for the corresponding intra_chroma_pred_mode can be discarded prior to the entropy coding. Or, in other words, the first bin is inferred to be 0 and hence not coded. This single binarization table is used for both sps_cclm_enabled_flag equal to 0 and 1 cases. The first two bins in Table 2-4 are context coded with its own context model, and the rest bins are bypass coded.

In addition, in order to reduce luma-chroma latency in dual tree, when the 64×64 luma coding tree node is partitioned with Not Split (and ISP is not used for the 64×64 CU) or QT, the chroma CUs in 32×32/32×16 chroma coding tree node is allowed to use CCLM in the following way:
If the 32×32 chroma node is not split or partitioned QT split, all chroma CUs in the 32×32 node can use CCLM
If the 32×32 chroma node is partitioned with Horizontal BT, and the 32×16 child node does not split or uses Vertical BT split, all chroma CUs in the 32×16 chroma node can use CCLM.

In all the other luma and chroma coding tree split conditions, CCLM is not allowed for chroma CU.

### 2.8. Multi-Model Linear Model (MMLM)

With MMLM, there can be more than one linear models between the luma samples and chroma samples in a CU. In this method, neighboring luma samples and neighboring chroma samples of the current block are classified into several groups, each group is used as a training set to derive a linear model (i.e., particular α and β are derived for a particular group). Furthermore, the samples of the current luma block is also classified based on the same rule for the classification of neighboring luma samples.

The neighboring samples can be classified into M groups, where M is 2 or 3. The MMLM method with M=2 and M=3 are designed as two appended Chroma prediction modes named MMLM2 and MMLM3, besides the original LM mode. The encoder chooses the optimal mode in the RDO process and signal the mode. When M is equal to 2, FIG. 10 shows an example of classifying the neighboring samples into two groups. Threshold is calculated as the average value of the neighboring reconstructed Luma samples. A neighboring sample with Rec′L[x,y]<=Threshold is classified into group 1; while a neighboring sample with Rec′L[x,y]>Threshold is classified into group 2. Similar to CCLM, there are 3 modes in MMLM, namely MMLM, MMLM_T, and MMLM_L. Two models are derived as

$$\{ \begin{matrix}P r e {d}_{C} [ x , y ] = {α}_{1} \times {Rec}_{L}^{′} [ x , y ] + {β}_{1} & if {Rec}_{L}^{′} [ x , y ] \leq Threshold \\ P r e {d}_{C} [ x , y ] = {α}_{2} \times {Rec}_{L}^{′} [ x , y ] + {β}_{2} & if {Rec}_{L}^{′} [ x , y ] > Threshold\end{matrix} \qquad ( 2 - 8 )$$

The threshold which is the average of the luma reconstructed neighboring samples. The linear model of each class is derived by using the Least-Mean-Square (LMS) method, if enabled, or min/max method of VVC.

### 2.9. Position Dependent Intra Prediction Combination

In VVC, the results of intra prediction of DC, planar and several angular modes are further modified by a position dependent intra prediction combination (PDPC) method. PDPC is an intra prediction method which invokes a combination of the boundary reference samples and HEVC style intra prediction with filtered boundary reference samples. PDPC is applied to the following intra modes without signalling: planar, DC, intra angles less than or equal to horizontal, and intra angles greater than or equal to vertical and less than or equal to 80. If the current block is BDPCM mode or MRL index is larger than 0, PDPC is not applied.

The prediction sample pred (x′ y′) is predicted using an intra prediction mode (DC, planar, angular) and a linear combination of reference samples according to the Equation 2-8 as follows:

pred (x′y′)=Clip (0,(1<<BitDepth)−1,(wL×R_{-1,y′}+wT×R_{x′,-1}+(64−wL−wT)×pred(x′,y′)+32)>>6) (2-9)

where R_{x,-1}, R_{-1,y} represent the reference samples located at the top and left boundaries of current sample (x, y), respectively.

If PDPC is applied to DC, planar, horizontal, and vertical intra modes, additional boundary filters are not needed, as required in the case of HEVC DC mode boundary filter or horizontal/vertical mode edge filters. PDPC process for DC and Planar modes is identical. For angular modes, if the current angular mode is HOR_IDX or VER_IDX, left or top reference samples is not used, respectively. The PDPC weights and scale factors are dependent on prediction modes and the block sizes. PDPC is applied to the block with both width and height greater than or equal to 4.

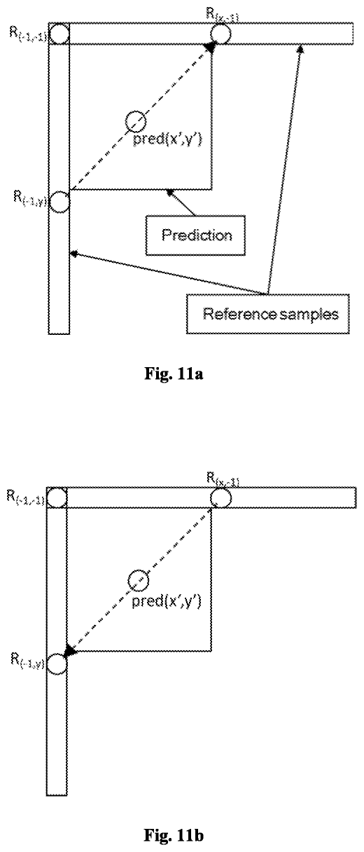

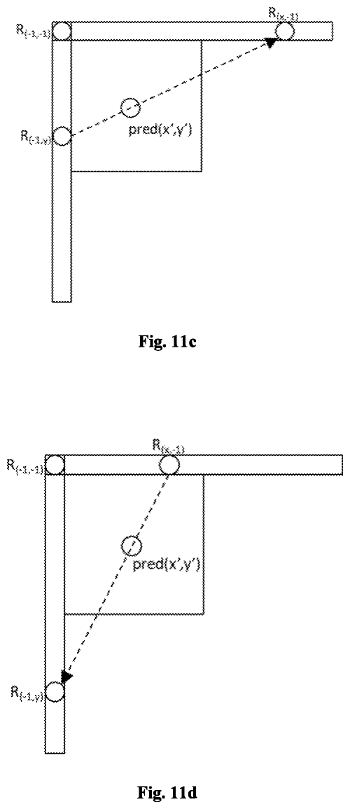

FIGS. 11a-11d illustrate the definition of reference samples (R_{x,-1} and R_{-1,y}) for PDPC applied over various prediction modes. The prediction sample pred(x′, y′) is located at (x′, y′) within the prediction block. As an example, the coordinate x of the reference sample R_{x,-1} is given by: x=x′+y′+1, and the coordinate y of the reference sample R_{-1,y} is similarly given by: y=x′+y′+1 for the diagonal modes. For the other angular mode, the reference samples R_{x,-1} and R_{-1,y} could be located in fractional sample position. In this case, the sample value of the nearest integer sample location is used.

### 2.10. Gradient PDPC

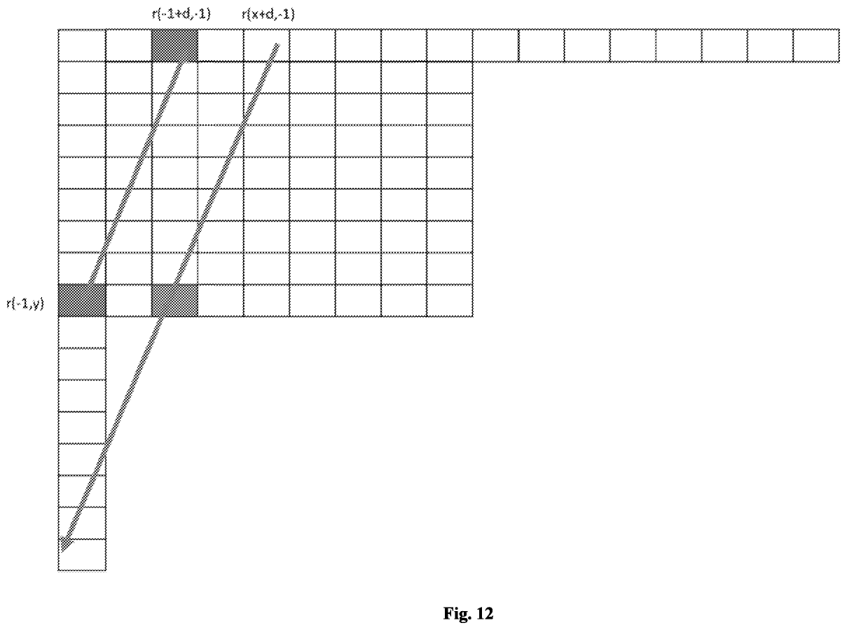

The gradient-based approach is extended for non-vertical/non-horizontal mode, as shown in FIG. 12. Here, the gradient is computed as r(−1, y)−r(−1+d,−1), where d is the horizontal displacement depending on the angular direction. A few points to note here:

The gradient term r(−1, y)−r(−1+d,−1) is needed to be computed once for every row, as it does not depend on the x position.

The computation of d is already part of original intra prediction process which can be reused, so a separate computation of d is not needed. Accordingly, d is in 1/32 pixel accuracy

We have used two tap (linear) filtering when d is at fractional position, i.e., if dPos is the displacement in 1/32 pixel accuracy, dInt is the (floored) integer part (dPos>>5), and dFract is the fractional part in 1/32 pixel accuracy (dPos & 31), then r(−1+d) is computed as:

r(−1+d)=(32−dFrac)*r(−1+dInt)+dFrac*r(−1+dInt+1)

This 2 tap filtering is performed once per row (if needed), as explained in a.

Finally, the prediction signal is computed

p(x,y)=Clip(((64−wL(x))*p(x,y)+wL(x)*(r(−1,y)−r(−1+d,−1))+32)>>6)

Where wL(x)=32>>((x<<1)>>nScale2), and nScale2=(log 2(nTbH)+log 2(nTbW)−2)>>2, which are the same as vertical/horizontal mode. In a nutshell, the same process is applied compared to vertical/horizontal mode (in fact, d=0 indicates vertical/horizontal mode).

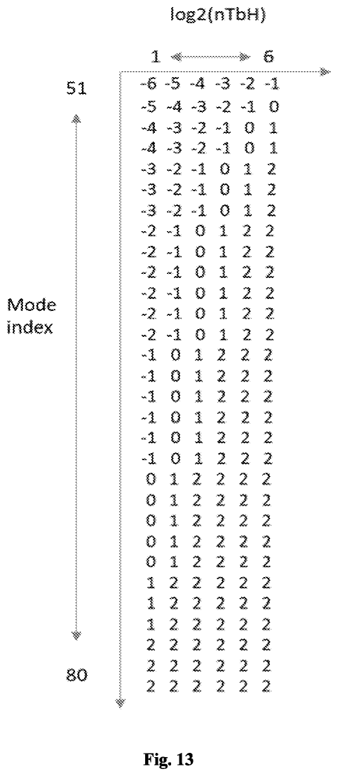

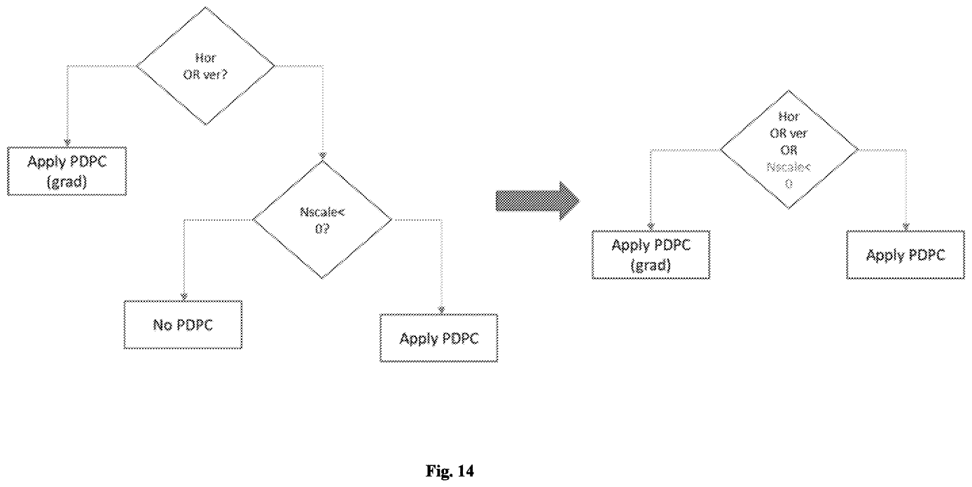

Second, we activate the gradient based approach for non-vertical/non-horizontal mode when (nScale<0) or when PDPC can't be applied due to unavailability of secondary reference sample. We have shown the values of nScale in FIG. 13, with respect to TB size and angular mode, to better visualize the cases where gradient approach is used. Additionally, in FIG. 14, we have shown the flowchart for current and proposed PDPC.

### 2.11. Secondary MPM

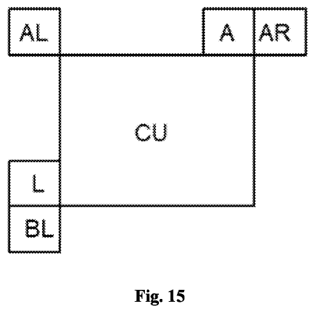

Secondary MPM lists is introduced as described in JVET-D0114. The existing primary MPM (PMPM) list consists of 6 entries and the secondary MPM (SMPM) list includes 16 entries. A general MPM list with 22 entries is constructed first, and then the first 6 entries in this general MPM list are included into the PMPM list, and the rest of entries form the SMPM list. The first entry in the general MPM list is the Planar mode. The remaining entries are composed of the intra modes of the left (L), above (A), below-left (BL), above-right (AR), and above-left (AL) neighbouring blocks as shown in FIG. 15, the directional modes with added offset from the first two available directional modes of neighbouring blocks, and the default modes.

If a CU block is vertically oriented, the order of neighbouring blocks is A, L, BL, AR, AL; otherwise, it is L, A, BL, AR, AL.

A PMPM flag is parsed first, if equal to 1 then a PMPM index is parsed to determine which entry of the PMPM list is selected, otherwise the SPMPM flag is parsed to determine whether to parse the SMPM index or the remaining modes.

### 2.12. 6-Tap Intra Interpolation Filter

To improve prediction accuracy, it is proposed to replace 4-tap Cubic interpolation filter with 6-tap interpolation filter, the filter coefficients are derived based on the same polynomial regression model, but with polynomial order of 6.

Filter coefficients are listed below,

{ 0, 0, 256, 0, 0, 0 }, // 0/32 position
{ 0, −4, 253, 9, −2, 0 }, // 1/32 position
{ 1, −7, 249, 17, −4, 0 }, // 2/32 position
{ 1, −10, 245, 25, −6, 1 }, // 3/32 position
{ 1, −13, 241, 34, −8, 1 }, // 4/32 position
{ 2, −16, 235, 44, −10, 1 }, // 5/32 position
{ 2, −18, 229, 53, −12, 2 }, // 6/32 position
{ 2, −20, 223, 63, −14, 2 }, // 7/32 position
{ 2, −22, 217, 72, −15, 2 }, // 8/32 position
{ 3, −23, 209, 82, −17, 2 }, // 9/32 position
{ 3, −24, 202, 92, −19, 2 }, // 10/32 position
{ 3, −25, 194, 101, −20, 3 }, // 11/32 position
{ 3, −25, 185, 111, −21, 3 }, // 12/32 position
{ 3, −26, 178, 121, −23, 3 }, // 13/32 position
{ 3, −25, 168, 131, −24, 3 }, // 14/32 position
{ 3, −25, 159, 141, −25, 3 }, // 15/32 position
{ 3, −25, 150, 150, −25, 3 }, // half-pel position

The reference samples used for interpolation come from reconstructed samples or padded as in HEVC, so that the conditional check on reference sample availability is not needed.

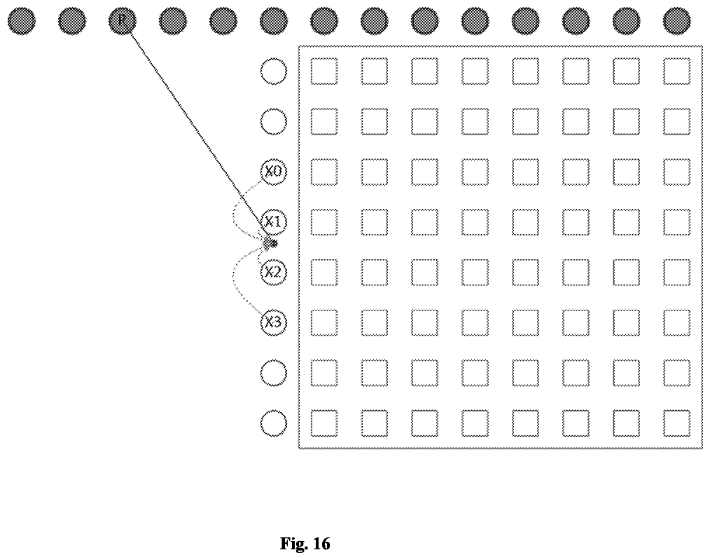

Instead of using nearest rounding operation to derive the extended Intra reference sample, it is proposed to use 4-tap Cubic interpolation filter. As shown in an example in FIG. 16, to derive the value of reference sample P, a four tap interpolation filter is used, while in JEM-3.0 or HM, P is directly set as X1.

### 2.13. Multiple Reference Line (MRL) Intra Prediction

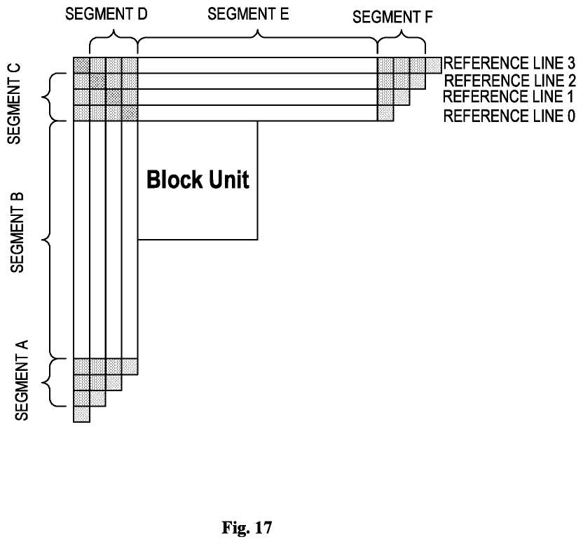

Multiple reference line (MRL) intra prediction uses more reference lines for intra prediction. In FIG. 17, an example of 4 reference lines is depicted, where the samples of segments A and F are not fetched from reconstructed neighbouring samples but padded with the closest samples from Segment B and E, respectively. HEVC intra-picture prediction uses the nearest reference line (i.e., reference line 0). In MRL, 2 additional lines (reference line 1 and reference line 2) are used.

The index of selected reference line (mrl_idx) is signalled and used to generate intra predictor. For reference line index, which is greater than 0, only include additional reference line modes in MPM list and only signal MPM index without remaining mode. The reference line index is signalled before intra prediction modes, and Planar mode is excluded from intra prediction modes in case a nonzero reference line index is signalled.

MRL is disabled for the first line of blocks inside a CTU to prevent using extended reference samples outside the current CTU line. Also, PDPC is disabled when additional line is used. For MRL mode, the derivation of DC value in DC intra prediction mode for non-zero reference line indices are aligned with that of reference line index 0. MRL requires the storage of 3 neighbouring luma reference lines with a CTU to generate predictions. The Cross-Component Linear Model (CCLM) tool also requires 3 neighbouring luma reference lines for its down-sampling filters. The definition of MRL to use the same 3 lines is aligned as CCLM to reduce the storage requirements for decoders.

### 2.14. Intra Sub-Partitions (ISP)

The intra sub-partitions (ISP) divides luma intra-predicted blocks vertically or horizontally into 2 or 4 sub-partitions depending on the block size. For example, minimum block size for ISP is 4×8 (or 8×4). If block size is greater than 4×8 (or 8×4) then the corresponding block is divided by 4 sub-partitions. It has been noted that the M×128 (with M≤64) and 128×N (with N≤64) ISP blocks could generate a potential issue with the 64×64 VDPU. For example, an M×128 CU in the single tree case has an M×128 luma TB and two corresponding

$$\frac{M}{2} \times 64$$

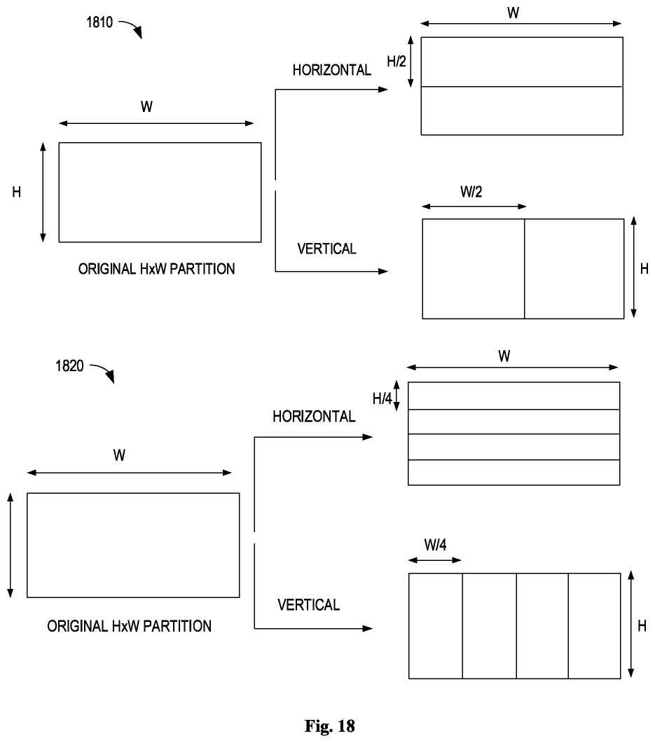

chroma TBs. If the CU uses ISP, then the luma TB will be divided into four M×32 TBs (only the horizontal split is possible), each of them smaller than a 64×64 block. However, in the current design of ISP chroma blocks are not divided. Therefore, both chroma components will have a size greater than a 32×32 block. Analogously, a similar situation could be created with a 128×N CU using ISP. Hence, these two cases are an issue for the 64×64 decoder pipeline. For this reason, the CU sizes that can use ISP is restricted to a maximum of 64×64. FIG. 18 shows an example 1810 of sub-partitions for 4×8 and 8×4 CUs and an example 1820 of sub-partitions for CUs other than 4×8, 8×4 and 4×4.

In ISP, the dependence of 1×N/2×N subblock prediction on the reconstructed values of previously decoded 1×N/2×N subblocks of the coding block is not allowed so that the minimum width of prediction for subblocks becomes four samples. For example, an 8×N (N>4) coding block that is coded using ISP with vertical split is split into two prediction regions each of size 4×N and four transforms of size 2×N. Also, a 4×N coding block that is coded using ISP with vertical split is predicted using the full 4×N block; four transform each of 1×N is used. Although the transform sizes of 1×N and 2×N are allowed, it is asserted that the transform of these blocks in 4×N regions can be performed in parallel. For example, when a 4×N prediction region contains four 1×N transforms, there is no transform in the horizontal direction; the transform in the vertical direction can be performed as a single 4×N transform in the vertical direction. Similarly, when a 4×N prediction region contains two 2×N transform blocks, the transform operation of the two 2×N blocks in each direction (horizontal and vertical) can be conducted in parallel. Thus, there is no delay added in processing these smaller blocks than processing 4×4 regular-coded intra blocks.

TABLE 2-5
Entropy coding coefficient group size

| Block Size | Coefficient group Size |
|---|---|
| 1 × N, N ≥ 16 | 1 × 16 |
| N × 1, N ≥ 16 | 16 × 1 |
| 2 × N, N ≥ 8 | 2 × 8 |
| N × 2, N ≥ 8 | 8 × 2 |
| All other possible M × N cases | 4 × 4 |

For each sub-partition, reconstructed samples are obtained by adding the residual signal to the prediction signal. Here, a residual signal is generated by the processes such as entropy decoding, inverse quantization and inverse transform. Therefore, the reconstructed sample values of each sub-partition are available to generate the prediction of the next sub-partition, and each sub-partition is processed repeatedly. In addition, the first sub-partition to be processed is the one containing the top-left sample of the CU and then continuing downwards (horizontal split) or rightwards (vertical split). As a result, reference samples used to generate the sub-partitions prediction signals are only located at the left and above sides of the lines. All sub-partitions share the same intra mode. The followings are summary of interaction of ISP with other coding tools.
Multiple Reference Line (MRL): if a block has an MRL index other than 0, then the ISP coding mode will be inferred to be 0 and therefore ISP mode information will not be sent to the decoder.
Entropy coding coefficient group size: the sizes of the entropy coding subblocks have been modified so that they have 16 samples in all possible cases, as shown in Table 2-5. Note that the new sizes only affect blocks produced by ISP in which one of the dimensions is less than 4 samples. In all other cases coefficient groups keep the 4×4 dimensions.
CBF coding: it is assumed to have at least one of the sub-partitions has a non-zero CBF. Hence, if n is the number of sub-partitions and the first n−1 sub-partitions have produced a zero CBF, then the CBF of the n-th sub-partition is inferred to be 1.
Transform size restriction: all ISP transforms with a length larger than 16 points uses the DCT-II.
MTS flag: if a CU uses the ISP coding mode, the MTS CU flag will be set to 0 and it will not be sent to the decoder. Therefore, the encoder will not perform RD tests for the different available transforms for each resulting sub-partition. The transform choice for the ISP mode will instead be fixed and selected according the intra mode, the processing order and the block size utilized. Hence, no signalling is required. For example, let ty and ty be the horizontal and the vertical transforms selected respectively for the w×h sub-partition, where w is the width and h is the height. Then the transform is selected according to the following rules:
If w=1 or h=1, then there is no horizontal or vertical transform respectively.
If w≥4 and w≤16, t_{H}=DST-VII, otherwise, t_{H}=DCT-II
If h≥4 and h≤16, t_{V}=DST-VII, otherwise, t_{V}=DCT-II

In ISP mode, all 67 intra prediction modes are allowed. PDPC is also applied if corresponding width and height is at least 4 samples long. In addition, the reference sample filtering process (reference smoothing) and the condition for intra interpolation filter selection doesn't exist anymore, and Cubic (DCT-IF) filter is always applied for fractional position interpolation in ISP mode.

### 2.15. Matrix Weighted Intra Prediction (MIP)

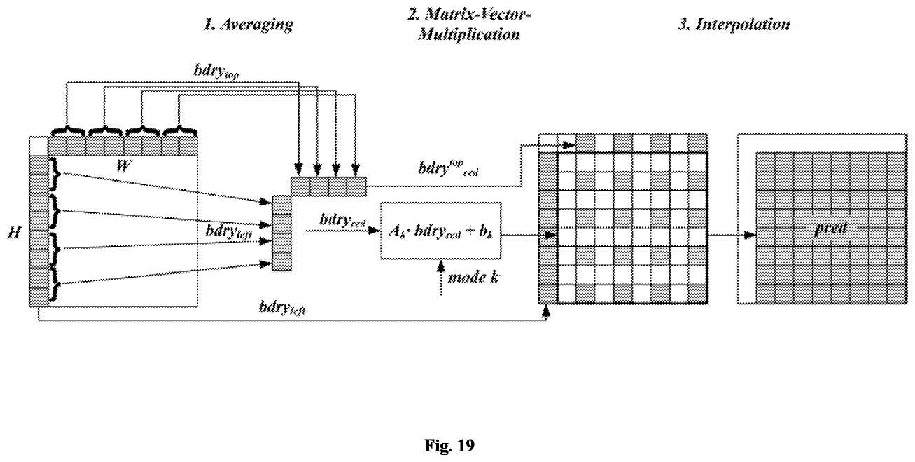

Matrix weighted intra prediction (MIP) method is a newly added intra prediction technique into VVC. For predicting the samples of a rectangular block of width W and height H, matrix weighted intra prediction (MIP) takes one line of H reconstructed neighbouring boundary samples left of the block and one line of W reconstructed neighbouring boundary samples above the block as input. If the reconstructed samples are unavailable, they are generated as it is done in the conventional intra prediction. The generation of the prediction signal is based on the following three steps, which are averaging, matrix vector multiplication and linear interpolation as shown in FIG. 19.

### 2.15.1. Averaging Neighbouring Samples

Among the boundary samples, four samples or eight samples are selected by averaging based on block size and shape. Specifically, the input boundaries bdry^{top} and bdry^{left} are reduced to smaller boundaries

$${bdry}_{red}^{top} and {bdry}_{red}^{left}$$

by averaging neighbouring boundary samples according to predefined rule depends on block size. Then, the two reduced boundaries

$${bdry}_{red}^{top} and {bdry}_{red}^{left}$$

are concatenated to a reduced boundary vector bdry_{red} which is thus of size four for blocks of shape 4×4 and of size eight for blocks of all other shapes. If mode refers to the MIP-mode, this concatenation is defined as follows:

$${bdry}_{red} = \{ \begin{matrix}[ {bdry}_{red}^{top} , {bdry}_{red}^{left} ] & for W = H = 4 and mode < 18 \\ [ {bdry}_{red}^{left} , {bdry}_{red}^{top} ] & for W = H = 4 and mode \geq 18 \\ [ {bdry}_{red}^{top} , {bdry}_{red}^{left} ] & for max ( W , H ) = 8 and mode < 10 \\ [ {bdry}_{red}^{left} , {bdry}_{red}^{top} ] & for max ( W , H ) = 8 and mode \geq 10 \\ [ {bdry}_{red}^{top} , {bdry}_{red}^{left} ] & for max ( W , H ) > 8 and mode < 6 \\ [ {bdry}_{red}^{left} , {bdry}_{red}^{top} ] & for max ( W , H ) > 8 and mode \geq 6.\end{matrix} \qquad ( 2 - 10 )$$

### 2.15.2. Matrix Multiplication

A matrix vector multiplication, followed by addition of an offset, is carried out with the averaged samples as an input. The result is a reduced prediction signal on a subsampled set of samples in the original block. Out of the reduced input vector bdry_{red} a reduced prediction signal pred_{red}, which is a signal on the down-sampled block of width W_{red} and height H_{red} is generated. Here, W_{red} and H_{red} are defined as:

$${W}_{red} = \{ \begin{matrix}4 & for max ( W , H ) \leq 8 \\ min ( W , 8 ) & for max ( W , H ) > 8\end{matrix} \qquad ( 2 - 11 )$$

$${H}_{red} = \{ \begin{matrix}4 & for max ( W , H ) \leq 8 \\ min ( H , 8 ) & for max ( W , H ) > 8\end{matrix} \qquad ( 2 - 12 )$$

The reduced prediction signal predred is computed by calculating a matrix vector product and adding an offset:

pred_{red}=A·bdry_{red}+b. (2-13)

Here, A is a matrix that has W_{red}·H_{red} rows and 4 columns if W=H=4 and 8 columns in all other cases. b is a vector of size W_{red}·H_{red}. The matrix A and the offset vector b are taken from one of the sets S₀, S₁, S₂. One defines an index idx=idx(W, H) as follows:

$$i d x ( W , H ) = \{ \begin{matrix}0 & for W = H = 4 \\ 1 & for max ( W , H ) = 8 \\ 2 & for max ( W , H ) > 8.\end{matrix} \qquad ( 2 - 14 )$$

Here, each coefficient of the matrix A is represented with 8 bit precision. The set S₀ consists of 16 matrices

$${A}_{0}^{i} ,$$

i∈{0, . . . , 15} each of which has 16 rows and 4 columns and 16 offset vectors

$${b}_{0}^{i} ,$$

i∈{0, . . . , 16}each of size 16. Matrices and offset vectors of that set are used for blocks of size 4×4. The set S₁ consists of 8 matrices

$${A}_{1}^{i} ,$$

i∈{0, . . . , 7}, each of which has 16 rows and 8 columns and 8 offset vectors

$${b}_{1}^{i} ,$$

i∈{0, . . . , 7} each of size 16. The set S₂ consists of 6 matrices

$${A}_{2}^{i} ,$$

i∈{0, . . . , 5}, each of which has 64 rows and 8 columns and of 6 offset vectors

$${b}_{2}^{i} ,$$

i∈{0, . . . , 5} of size 64.

### 2.15.3. Interpolation

The prediction signal at the remaining positions is generated from the prediction signal on the subsampled set by linear interpolation which is a single step linear interpolation in each direction. The interpolation is performed firstly in the horizontal direction and then in the vertical direction regardless of block shape or block size.

2.15.4. Signalling of MIP Mode and Harmonization with Other Coding Tools

For each Coding Unit (CU) in intra mode, a flag indicating whether an MIP mode is to be applied or not is sent. If an MIP mode is to be applied, MIP mode (predModeIntra) is signalled. For an MIP mode, a transposed flag (isTransposed), which determines whether the mode is transposed, and MIP mode Id (modeId), which determines which matrix is to be used for the given MIP mode is derived as follows

isTransposed=predModeIntra&1

modeId=predModeIntra>>1 (2-15)

MIP coding mode is harmonized with other coding tools by considering following aspects:
LFNST is enabled for MIP on large blocks. Here, the LFNST transforms of planar mode are used
The reference sample derivation for MIP is performed exactly as for the conventional intra prediction modes
For the up-sampling step used in the MIP-prediction, original reference samples are used instead of down-sampled ones
Clipping is performed before up-sampling and not after up-sampling
MIP is allowed up to 64×64 regardless of the maximum transform size

The number of MIP modes is 32 for sizeId=0, 16 for sizeId=1 and 12 for sizeId=2

### 2.16. Decoder-Side Intra Mode Derivation

In JEM-2.0 intra modes are extended to 67 from 35 modes in HEVC, and they are derived at encoder and explicitly signalled to decoder. A significant amount of overhead is spent on intra mode coding in JEM-2.0. For example, the intra mode signalling overhead may be up to 5~10% of overall bitrate in all intra coding configuration. This contribution proposes the decoder-side intra mode derivation approach to reduce the intra mode coding overhead while keeping prediction accuracy.

To reduce the overhead of intra mode signalling, this contribution presents a decoder-side intra mode derivation (DIMD) approach. In the proposed approach, instead of signalling intra mode explicitly, the information is derived at both encoder and decoder from the neighbouring reconstructed samples of current block. The intra mode derived by DIMD is used in two ways:
1) For 2N×2N CUs, the DIMD mode is used as the intra mode for intra prediction when the corresponding CU-level DIMD flag is turned on;
2) For N×N CUs, the DIMD mode is used to replace one candidate of the existing MPM list to improve the efficiency of intra mode coding.

### 2.16.1. Templated Based Intra Mode Derivation

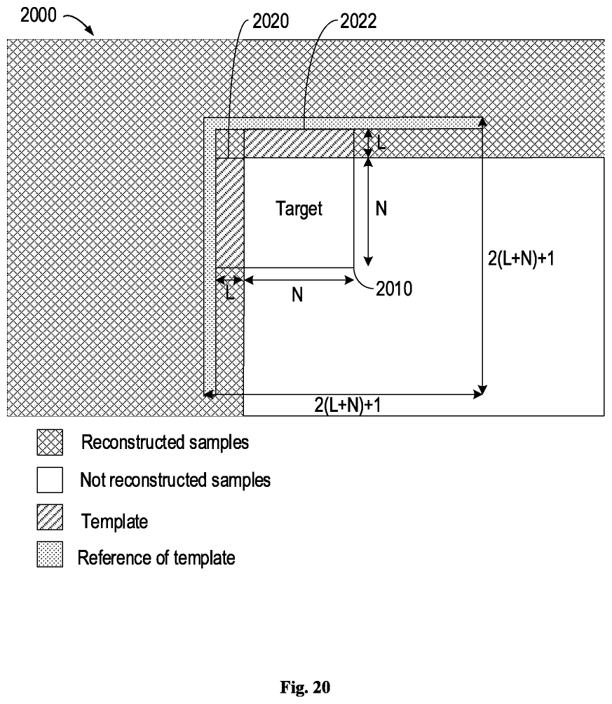

FIG. 20 is a schematic diagram 2000 illustrating target samples, template samples and the reference samples of template used in the DIMD. As illustrated in FIG. 20, the target denotes the current block (of block size N) for which intra prediction mode is to be estimated. The template (indicated by the patterned region in FIG. 20) specifies a set of already reconstructed samples, which are used to derive the intra mode. The template size is denoted as the number of samples within the template that extends to the above and the left of the target unit, i.e., L. In the current implementation, a template size of 2 (i.e., L=2) is used for 4×4 and 8×8 blocks and a template size of 4 (i.e., L=4) is used for 16×16 and larger blocks. The reference of template (indicated by the dotted region in FIG. 20) refers to a set of neighbouring samples from above and left of the template, as defined by JEM-2.0. Unlike the template samples which are always from reconstructed region, the reference samples of template may not be reconstructed yet when encoding/decoding the target unit. In this case, the existing reference samples substitution algorithm of JEM-2.0 is utilized to substitute the unavailable reference samples with the available reference samples.

For each intra prediction mode, the DIMD calculates the absolute difference (SAD) between the reconstructed template samples and its prediction samples obtained from the reference samples of the template. The intra prediction mode that yields the minimum SAD is selected as the final intra prediction mode of the target unit.

### 2.16.2. DIMD for Intra 2N×2N CUs

For intra 2N×2N CUs, the DIMD is used as one additional intra mode, which is adaptively selected by comparing the DIMD intra mode with the optimal normal intra mode (i.e., being explicitly signalled). One flag is signalled for each intra 2N×2N CU to indicate the usage of the DIMD. If the flag is one, then the CU is predicted using the intra mode derived by DIMD; otherwise, the DIMD is not applied and the CU is predicted using the intra mode explicitly signalled in the bit-stream. When the DIMD is enabled, chroma components always reuse the same intra mode as that derived for luma component, i.e., DM mode.

Additionally, for each DIMD-coded CU, the blocks in the CU can adaptively select to derive their intra modes at either PU-level or TU-level. Specifically, when the DIMD flag is one, another CU-level DIMD control flag is signalled to indicate the level at which the DIMD is performed. If this flag is zero, it means that the DIMD is performed at the PU level and all the TUs in the PU use the same derived intra mode for their intra prediction; otherwise (i.e., the DIMD control flag is one), it means that the DIMD is performed at the TU level and each TU in the PU derives its own intra mode.

Further, when the DIMD is enabled, the number of angular directions increases to 129, and the DC and planar modes still remain the same. To accommodate the increased granularity of angular intra modes, the precision of intra interpolation filtering for DIMD-coded CUs increases from 1/32-pel to 1/64-pel. Additionally, in order to use the derived intra mode of a DIMD coded CU as MPM candidate for neighbouring intra blocks, those 129 directions of the DIMD-coded CUs are converted to “normal” intra modes (i.e., 65 angular intra directions) before they are used as MPM.

### 2.16.3. DIMD for Intra N×N CUs

In the proposed method, intra modes of intra N×N CUs are always signalled. However, to improve the efficiency of intra mode coding, the intra modes derived from DIMD are used as MPM candidates for predicting the intra modes of four PUs in the CU. In order to not increase the overhead of MPM index signalling, the DIMD candidate is always placed at the first place in the MPM list and the last existing MPM candidate is removed. Also, pruning operation is performed such that the DIMD candidate will not be added to the MPM list if it is redundant.

### 2.16.4. Intra Mode Search Algorithm of DIMD

In order to reduce encoding/decoding complexity, one straightforward fast intra mode search algorithm is used for DIMD. Firstly, one initial estimation process is performed to provide a good starting point for intra mode search. Specifically, an initial candidate list is created by selecting N fixed modes from the allowed intra modes. Then, the SAD is calculated for all the candidate intra modes and the one that minimizes the SAD is selected as the starting intra mode. To achieve a good complexity/performance trade-off, the initial candidate list consists of 11 intra modes, including DC, planar and every 4-th mode of the 33 angular intra directions as defined in HEVC, i.e., intra modes 0, 1, 2, 6, 10 . . . 30, 34.

If the starting intra mode is either DC or planar, it is used as the DIMD mode. Otherwise, based on the starting intra mode, one refinement process is then applied where the optimal intra mode is identified through one iterative search. It works by comparing at each iteration the SAD values for three intra modes separated by a given search interval and maintain the intra mode that minimize the SAD. The search interval is then reduced to half, and the selected intra mode from the last iteration will serve as the center intra mode for the current iteration. For the current DIMD implementation with 129 angular intra directions, up to 4 iterations are used in the refinement process to find the optimal DIMD intra mode.

### 2.17. Decoder-Side Intra Mode Derivation by Calculating the Gradients of Neighbouring Samples

Three angular modes are selected from a Histogram of Gradient (HoG) computed from the neighboring pixels of current block. Once the three modes are selected, their predictors are computed normally and then their weighted average is used as the final predictor of the block. To determine the weights, corresponding amplitudes in the HoG are used for each of the three modes. The DIMD mode is used as an alternative prediction mode and is always checked in the FullRD mode.

Current version of DIMD has modified some aspects in the signaling, HoG computation and the prediction fusion. The purpose of this modification is to improve the coding performance as well as addressing the complexity concerns raised during the last meeting (i.e., throughput of 4×4 blocks). The following sections describe the modifications for each aspect.

### 2.17.1. Signalling

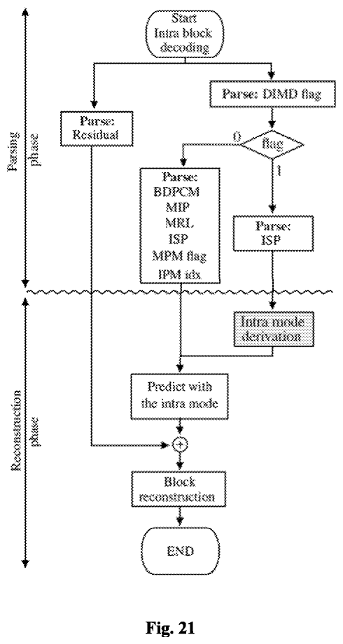

FIG. 21 shows the order of parsing flags/indices in VTM5, integrated with the proposed DIMD.

As can be seen, the DIMD flag of the block is parsed first using a single CABAC context, which is initialized to the default value of 154.

If flag==0, then the parsing continues normally.

Else (if flag==1), only the ISP index is parsed and the following flags/indices are inferred to be zero: BDPCM flag, MIP flag, MRL index. In this case, the entire IPM parsing is also skipped.

During the parsing phase, when a regular non-DIMD block inquires the IPM of its DIMD neighbor, the mode PLANAR IDX is used as the virtual IPM of the DIMD block.

### 2.17.2. Texture Analysis

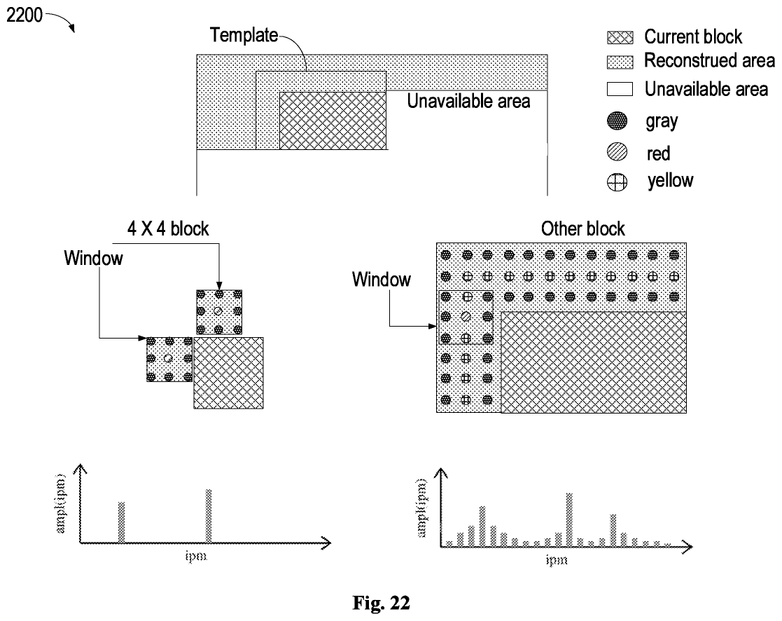

The texture analysis of DIMD includes a Histogram of Gradient (HoG) computation (FIG. 22). The HoG computation is carried out by applying horizontal and vertical Sobel filters on pixels in a template of width 3 around the block. Except, if above template pixels fall into a different CTU, then they will not be used in the texture analysis.

Once computed, the IPMs corresponding to two tallest histogram bars are selected for the block.

In previous versions, all pixels in the middle line of the template were involved in the HoG computation. However, the current version improves the throughput of this process by applying the Sobel filter more sparsely on 4×4 blocks. To this aim, only one pixel from left and one pixel from above are used. This is shown in FIG. 22. FIG. 22 is a schematic diagram 2200 illustrating HoG computation from a template of width 3 pixels.

In addition to reduction in the number of operations for gradient computation, this property also simplifies the selection of best 2 modes from the HoG, as the resulting HoG cannot have more than two non-zero amplitudes.

### 2.17.3. Prediction Fusion

Like the previous version in JVET-0342, the current version of the method also uses a fusion of three predictors for each block. However, the choice of prediction modes is different and makes use of the combined hypothesis intra-prediction method proposed in [2], where the Planar mode is considered to be used in combination with other modes when computing an intra-predicted candidate. In the current version, the two IPMs corresponding to two tallest HoG bars are combined with the Planar mode.

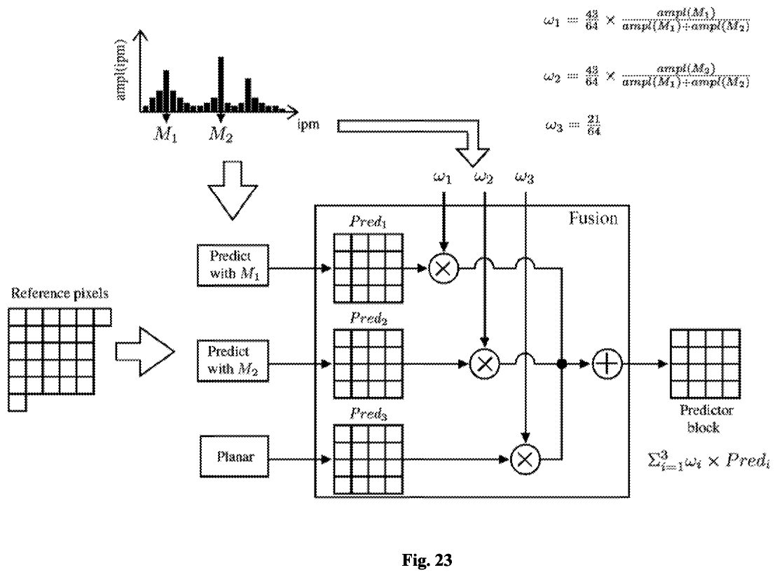

The prediction fusion is applied as a weighted average of the above three predictors. To this aim, the weight of planar is fixed to 21/64 (~1/3). The remaining weight of 43/64 (~2/3) is then shared between the two HoG IPMs, proportionally to the amplitude of their HoG bars. FIG. 23 visualises this process.

### 2.18. Template-Based Intra Mode Derivation (TIMD)

This contribution proposes a template-based intra mode derivation (TIMD) method using MPMs, in which a TIMD mode is derived from MPMs using the neighbouring template. The TIMD mode is used as an additional intra prediction method for a CU.

### 2.18.1. TIMD Mode Derivation

For each intra prediction mode in MPMs, The SATD between the prediction and reconstruction samples of the template is calculated. The intra prediction mode with the minimum SATD is selected as the TIMD mode and used for intra prediction of current CU. Position dependent intra prediction combination (PDPC) is included in the derivation of the TIMD mode.

### 2.18.2. TIMD Signalling

A flag is signalled in sequence parameter set (SPS) to enable/disable the proposed method. When the flag is true, a CU level flag is signalled to indicate whether the proposed TIMD method is used. The TIMD flag is signalled right after the MIP flag. If the TIMD flag is equal to true, the remaining syntax elements related to luma intra prediction mode, including MRL, ISP, and normal parsing stage for luma intra prediction modes, are all skipped.

2.18.3. Interaction with New Coding Tools

A DIMD method with prediction fusion using Planar was integrated in EE2. When EE2 DIMD flag is equal to true, the proposed TIMD flag is not signalled and set equal to false.

Similar to PDPC, Gradient PDPC is also included in the derivation of the TIMD mode.

When secondary MPM is enabled, both the primary MPMs and the secondary MPMs are used to derive the TIMD mode.

6-tap interpolation filter is not used in the derivation of the TIMD mode.

### 2.18.4. Modification of MPM List Construction in the Derivation of TIMD Mode

During the construction of MPM list, intra prediction mode of a neighbouring block is derived as Planar when it is inter-coded. To improve the accuracy of MPM list, when a neighbouring block is inter-coded, a propagated intra prediction mode is derived using the motion vector and reference picture and used in the construction of MPM list. This modification is only applied to the derivation of the TIMD mode.

2.18.5. TIMD with Fusion

Instead of selecting the only one mode with the smallest SATD cost, this contribution proposes to choose the first two modes with the smallest SATD costs for the intra modes derived using TIMD method and then fuse them with the weights, and such weighted intra prediction is used to code the current CU.

The costs of the two selected modes are compared with a threshold, in the test the cost factor of 2 is applied as follows:

costMode2<2 └costMode1.

If this condition is true, the fusion is applied, otherwise the only model is used.

Weights of the modes are computed from their SATD costs as follows:

weight1=costMode2/(costMode1+costMode2)

weight2=1−weight1

### 3. Problems

1. In current design of intra prediction for chroma components, the indication of intra prediction mode is signalled in the bitstream. However, the signalling of the indication may limit the compression efficiency, especially in the low bit rate scenarios.

2. In current design of DIMD and TIMD with fusion, division operation and floating point are used to derive the weights of each intra prediction mode, which is not hardware-friendly.

### 4. EMBODIMENTS OF THE PRESENT DISCLOSURE

Embodiments of the present disclosure below should be considered as examples to explain general concepts. These embodiments should not be interpreted in a narrow way. Furthermore, these embodiments can be combined in any manner.

In this disclosure, the term decoder-side derivation of intra prediction mode (DDIPM) represents a coding tool that derives intra prediction mode using previously decoded blocks/samples. In one example, the DDIPM could also be interpreted to a decoder-side intra mode derivation (DIMD) method or a template-based intra prediction mode (TIMD) method.

Fusion means using multiple predicted signals to get the final predicted signal for a video unit, in which each predicted signal is generated using one intra prediction mode.

The term ‘block’ may represent a coding block (CB), or a coding unit (CU), or a prediction block (PB), or a prediction unit (PU), or a transform block (TB), or a transform unit (TU), or a coding tree block (CTB), or a coding tree unit (CTU), or a rectangular region of samples/pixels.

In the following discussion, SatShift(x, n) is defined as

$$SatShift ( x , n ) = \{ \begin{matrix}( x + offsset 0 ≫ n & if x \geq 0 \\ - ( ( - x + offset 1 ) ≫ n ) & if x < 0\end{matrix}$$

Shift(x, n) is defined as Shift(x, n)=(x+offset0)>>n.

In one example, offset0 and/or offset1 are set to (1<<n)>>1 or (1<<(n−1)). In another example, offset0 and/or offset1 are set to 0.

In another example, offset0=offset1=((1<<n)>>1)−1 or ((1<<(n−1)))−1.

Clip3 (min, max, x) is defined as

$$Clip 3 ( Min , Max , x ) = \{ \begin{matrix}Min & if x < Min \\ Max & if x > Max \\ x & Otherwise\end{matrix}$$

### Intra Prediction Mode Derivation for Chroma Components

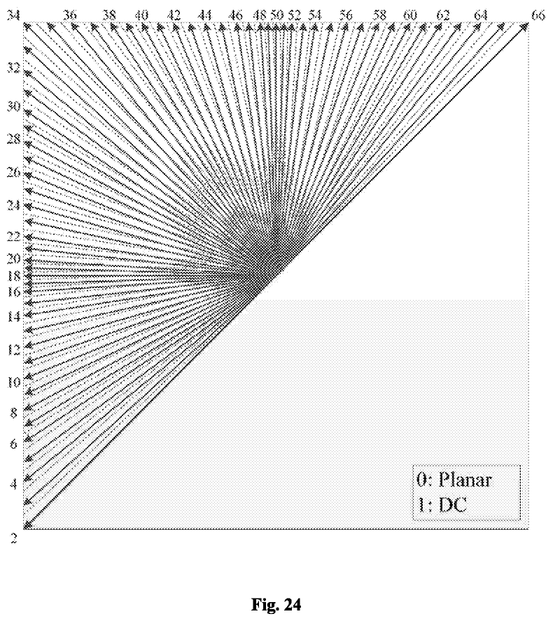

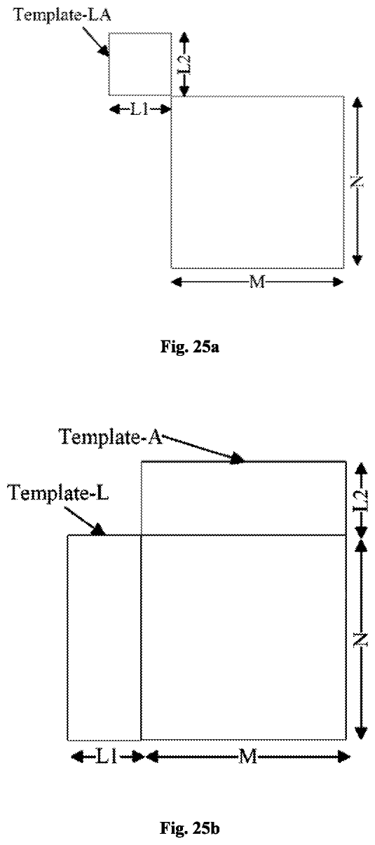

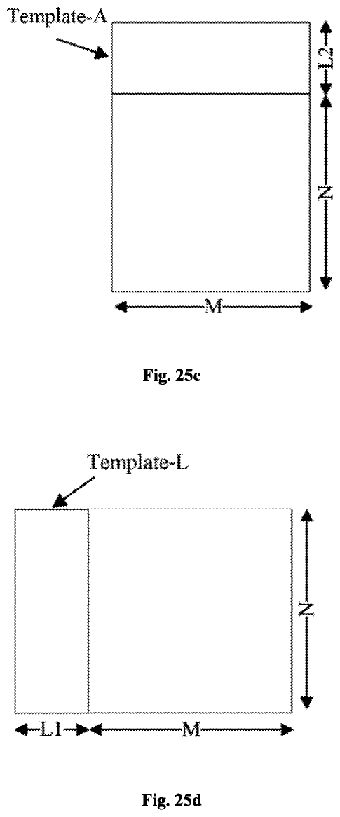

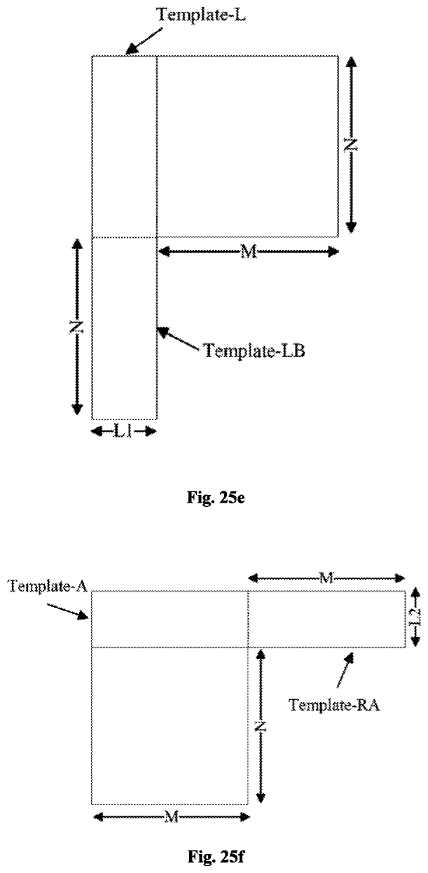

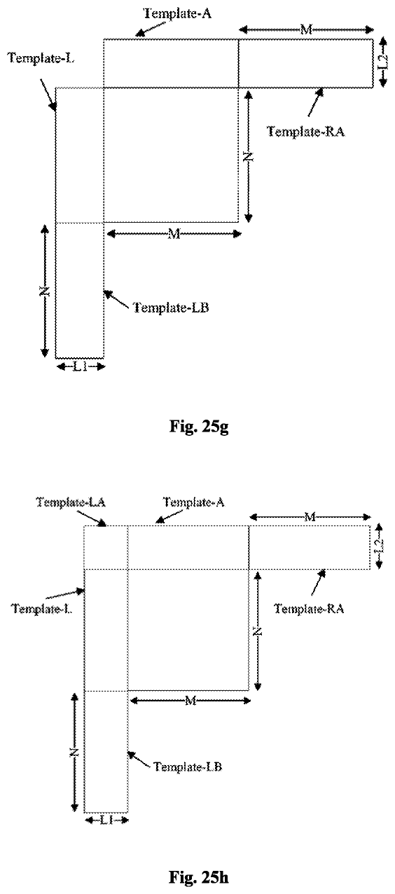

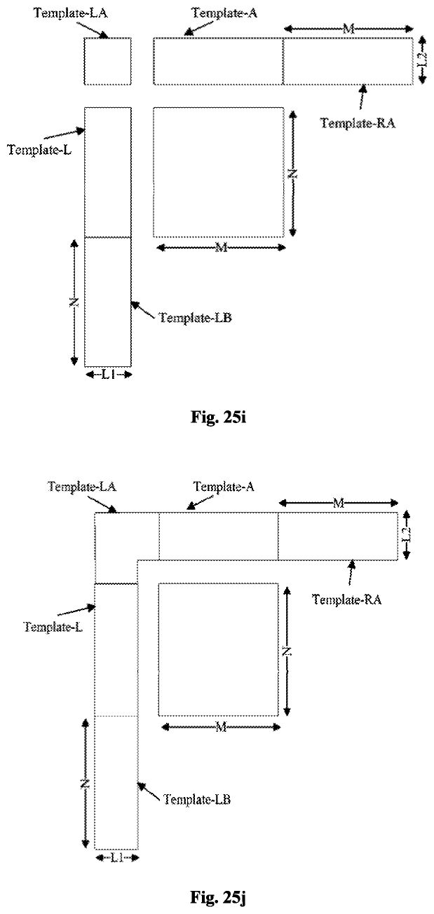

1. Instead of signalling an intra prediction mode (IPM) of a block for at least one chroma component, it is proposed to derive the IPM at decoder, which is used to get the prediction/reconstruction of the block for at least one chroma component, wherein the coded mode of the block is denoted as DDIPM_CHROMA.
a. In one example, a template used to derive the IPM for chroma components may consist of the neighbouring adjacent and/or non-adjacent reconstructed samples/pixels.
i. In one example, as shown in FIGS. 25a-25j, “Template-LA” consists of the neighbouring left-above reconstructed samples, and “Template-L” consists of the neighbouring left reconstructed samples, and “Template-A” consists of the neighbouring above reconstructed samples, and “Template-LB” consists of the neighbouring left-below reconstructed samples, and “Template-RA” consists of the neighbouring right-above reconstructed samples.
ii. In one example, the template may consist of the (adjacent and/or non-adjacent) neighbouring left, and/or above, and/or left-above, and/or left-below, and/or right-above reconstructed samples.
1) In one example, the template may only consist of neighbouring left-above reconstructed samples, or left reconstructed samples, or above reconstructed samples, or left-below reconstructed samples, or right-above reconstructed samples. Such as, one of “Template-LA” (e.g., FIG. 25a), “Template-L” (e.g., FIG. 25d), “Template-A” (e.g., FIG. 25c), “Template-LB”, and “Template-RA”.
2) In one example, the template may consist of the combined neighbouring reconstructed samples from left-above, and/or left, and/or above, and/or left-below, and/or right-above reconstructed samples.
a) In one example, the template may consist of “Template-L” and “Template-A”, such as example shown in FIG. 25b.
b) In one example, the template may consist of “Template-L” and “Template-LB”, such as an example shown in FIG. 25e.
c) In one example, the template may consist of “Template-A” and “Template-RA”, such as an example shown in FIG. 25f.
d) In one example, the template may consist of “Template-A”, “Template-L”, “Template-LB”, and “Template-RA”, such as an example shown in FIG. 25g.
e) In one example, the template may consist of “Template-LA”, “Template-A”, “Template-L”, “Template-LB”, and “Template-RA”, such as an example shown in FIG. 25h.
3) In one example, the template may be non-adjacent, such as an example shown in FIG. 25i and FIG. 25j.
iii. In one example, the template consists of samples of component A may be used to derive the IPM for component A. (e.g., A may be Cb or Cr).
iv. In one example, the template consists of samples of component A may be used to derive the IPM for component B. (e.g., A may be Cb, and B may be Cr. e.g., A may be Y, and B may be Cr).
1) In one example, A may consist of more than one components and B may consist of more than one components, such as A may be Cb and Cr, and B may be Cb and Cr.
b. In one example, during the derivation of the IPM for chroma components, intra prediction is processed on the template using one of IPMs from an IPM candidate list, and the IPM with the minimum cost is determined as the derived IPM.
i. In one example, the derivation of the IPM for chroma components may be same as the derivation of IPM for luma component.
1) In one example, the template (e.g., shape/size) used in the derivation of the IPM for chroma may be same as luma.
2) In one example, the IPM candidate list used to derive the IPM for chroma may be same as luma.
3) In one example, how to calculate the cost used to derive the IPM for chroma may be same as luma.
ii. In one example, the shape/size/dimensions of the template used to derive the IPM for chroma may be different from luma.
1) In one example, the template shape/size/width/height for chroma may depend on the template shape/size/width/height for luma. Denote the template size/width/height for chroma as S1/W1/H1, and the template size/width/height for luma as S2/W2/H2. SubWidthC and SubHeightC are defined in Table 2-1.
a) In one example, S1=S2/(SubWidth ‘SubHeight).
b) In one example, W1=W2/SubWidth.
c) In one example, H1=H2/SubHeight.
iii. In one example, the IPM candidate list used to derive the IPM for chroma may be different from the IPM candidate list used to derive the IPM for luma.
1) In one example, the IPM candidate list for chroma may consist of one or more IPMs that can be signalled explicitly in the conventional intra prediction modes (e.g., 35 IPMs in HEVC, or 67 IPMs in VVC), and/or one or more extended angular IPMs (e.g., shown in FIG. 24).
2) In one example, the number of IPMs in the IPM candidate list for chroma may be less than the number of IPMs in the IPM candidate list for luma.
3) In one example, the IPM candidate list for chroma may consist of cross-component prediction mode such as LM, and/or LM_T, and/or LM_L, and/or MMLM, and/or MMLM_T, and/or MMLM_L.
iv. In one example, how to derive the optimal IPM from the IPM candidate list for chroma may be different from luma.
1) In one example, partial or all IPMs may be used/checked in the intra prediction for the template during the derivation of the IPM for chroma.
2) In one example, early termination may be used during the derivation of the IPM for chroma.
a) In one example, when the cost of an IPM is less than T1, the IPM is determined as the derived IPM and all remaining unchecked IPMs in the IPM candidate list are skipped, wherein T1 is a threshold which may be pre-defined, or signalled in the bitstream, or dependent on the coding information.
i. In one example, T1 may depend on the number of IPMs that have been checked.
ii. In one example, T1 may depend on the costs of IPMs that have been checked.
3) In one example, the IPMs in the IPM candidate list may be reordered during the derivation of the IPM for chroma.
4) In one example, whether to and/or how to check the next one or more IPMs may depend on the costs of the IPMs that have been checked.
v. In one example, the sum of the absolute transformed difference (SATD) between the predicted samples and the reconstructed samples of the template may be calculated and used to derive the cost. (e.g., SATD may be used as the cost).
vi. Alternatively, the sum of the squared errors (SSE), or the sum of the absolute difference (SAD), or the mean removal sum of the absolute difference (MRSAD), or a subjective quality metric (e.g., the structural similarity index measure (SSIM)) may be calculated and used as the cost. (e.g., SSE or SAD or MRSAD or SSIM may be used as the cost).
1) Alternatively, the cost may be calculated in a form of D+lambda×R, wherein D is a metric of distortion such as SAD, SATD, SSE et. al, R represents the number of bits under consideration and lambda is a pre-defined factor or derived on-the-fly.
2) In one example, partial samples or all samples of the template may be used to calculate the cost.
3) In one example, both of the two Chroma components (e.g., Cb and Cr in YCbCr colour format, or B and R in RGB colour format) may be used to calculate the cost. Denote the cost of the first chroma component as C1, and the cost of the second chroma component as C2, and the total cost as C.
a) In one example, C=C1+C2.
b) In one example, C=w1′C1+w2′C2, wherein w1 and w2 are weighted factors.
i. In one example, w1=1−w2.
c) In one example, C=(w1′C1+w2′C2+offset)>>shift, wherein w1, w2, offset, and shift are integers.
d) In above examples, w1, w2, offset, and shift may be signalled in the bitstream, or pre-defined, or derived on-the-fly, or dependent on coding information.
vii. In one example, the reference samples used in the intra prediction for the template during the derivation of the IPM for chroma may be unfiltered.
1) Alternatively, the reference samples used in the intra prediction for the template during the derivation of the IPM may be filtered using the same way as intra prediction for chroma, or intra prediction for luma, or the derivation of the IPM for luma.
viii. In one example, the filtering method used to refine the predicted signal of intra prediction for the block (e.g., PDPC or gradient PDPC) may be used during the derivation of the IPM for chroma.
1) Alternatively, whether to or how to apply the filtering method used to refine the predicted signal of intra prediction for the template during the derivation of the IPM may be the same way as intra prediction for chroma, or intra prediction for luma, or the derivation of the IPM for luma.
ix. In one example, the interpolation filter used in the intra prediction for the template during the derivation of the IPM for chroma may be same as the interpolation filter used in intra prediction for chroma, or the interpolation filter used in intra prediction for luma, or the interpolation filter used in the intra prediction during the derivation of the IPM for luma.
1) Alternatively, the interpolation filter used in the intra prediction for the template during the derivation of the IPM for chroma may be different from the interpolation filter used in intra prediction for chroma, and/or the interpolation filter used in intra prediction for luma, and/or the interpolation filter used in the intra prediction for the template during the derivation of the IPM for luma.
x. In one example, the mode conversion process for extended IPMs in the derivation of the IPM for chroma or luma may be same as or different from the mode conversion process for extended IPMs used in intra prediction for chroma or luma.
c. In one example, a histogram of gradients (HoG) is built using the samples/pixels in the template, in which each bin is mapped to an IPM, and the IPM with the highest amplitude may be used as the derived IPM.
i. In one example, the derivation of the IPM for chroma (e.g., how to build the HoG, or the number of bins in the HoG, or how to map the bins to IPMs) may be same as luma.
ii. In one example, the shape/size/dimensions of the template for chroma components may be different from that used in the calculation of gradients for luma component.
1) Alternatively, the ratio of template size for chroma compared to luma may follow the ratio due to colour formats.
iii. In one example, the calculation of gradients for chroma may be different from the calculation of gradients for luma.
1) In one example, the Sobel operator, or Isotropic Sobel operator, or Roberts operator, or Prewitt operator, Laplacian operator, or Canny operator may be used to calculate the gradients.
iv. In one example, the number of bins in the HoG may be equal to or less than the number of conventional IPMs that can be signalled explicitly.
v. In one example, both of the chroma components may be used to calculate the gradients.
d. In above examples, only one of the chroma components (e.g., Cb or Cr in YCbCr colour format, or B or R in RGB colour format) may be used to derive the IPM (e.g., calculate the cost or calculate the gradients).
i. In one example, which chroma component is used may be signalled in the bitstream, or per-defined, or determined on-the-fly, or dependent on coding information.
ii. In one example, the derived IPM may be used in the intra prediction of the block for the two chroma components.
2. In one example, an IPM is derived using above methods for each chroma component individually.
a. In one example, the derivation of the IPM may be different for different chroma components.
b. In one example, the derived IPMs for the chroma components may be different.
c. In one example, the derived IPMs for the chroma components may be the same.
3. In above examples, more than one IPMs may be derived and use which IPM in the intra prediction for chroma components may be signalled in the bitstream, and/or determined on-the-fly, and/or dependent on coding information.
4. In one example, fusion of the predicted signals generated by more than one IPMs may be used as the final prediction of the block for chroma components.
a. In one example, the IPMs used in fusion may consist of one or more derived IPMs, and/or one or more pre-defined or signalled modes.
i. In one example, the pre-defined modes or signalled modes may be cross-component prediction mode such as LM, and/or LM_T, and/or LM_L, and/or MMLM, and/or MMLM_T, and/or MMLM_L.
ii. In one example, the pre-defined modes or signalled modes may be Planar, and/or DC, and/or horizontal mode, and/or vertical mode, and/or diagonal mode, and/or vertical diagonal mode.
b. In one example, different fusion methods may be applied, in which different fusion methods may refer to use different IPMs and/or different weighted factors in the fusion.
i. In one example, the weighted factors may be dependent on the cost or the amplitude during the derivation of the IPMs.
c. In above examples, whether to and/or how to fuse the predicted signals, and/or the number of the IPMs used in fusion, and/or the indication of the fusion method may be signalled in the bitstream, and/or determined on-the-fly, and/or dependent on coding information.
i. In one example, whether to and/or how to apply the fusion method may be dependent on the costs or the amplitudes of the derived IPMs.
1) In one example, denote the cost of the best derived IPM as Cost1, and the cost the second best derived IPM as Cost2, when Cost2 is less than T⊐Cost1, the fusion method may be applied, wherein T is a cost factor.

### General Claims

5. Whether to and/or how to apply the disclosed methods above may be signalled at sequence level/group of pictures level/picture in sequence level/slice level/tile group level, such as header/picture header/SPS/VPS/DPS/DCI/PPS/APS/slice header/tile group header.
6. Whether to and/or how to apply the disclosed methods above may be signalled at PB/TB/CB/PU/TU/CU/VPDU/CTU/CTU row/slice/tile/sub-picture/other kinds of region contains more than one sample or pixel.
7. Whether to and/or how to apply the disclosed methods above may be dependent on coded information, such as block size, colour format, single/dual tree partitioning, colour component, slice/picture type.
8. The proposed methods disclosed in this document may be used to generate intra prediction in other coding tools which require an intra prediction signal (e.g., the CIIP mode).
5. Other embodiments

### On Chroma DM Mode and Chroma Intra Prediction Mode Candidate List

1. When the DDIPM is applied to luma and chroma DM mode is applied, the final chroma intra prediction mode is dependent on the derived IPM in the DDIPM for luma.
a. In one example, the derived IPM for luma may be used as the final chroma intra prediction mode.
b. In one example, when the derived IPM for luma is not the same angle range of as traditional IPMs for chroma (e.g., mode range of the derived IPM for luma is [0, 130], and mode range of the traditional IPMs for chroma is [0, 66]), the derived IPM for luma may be modified to the range same as the traditional IPMs for chroma.
i. In one example, the modification may be defined as a mapping function, such as MAP131TO67 (x)=(x<2?x: ((x>>1)+1)), wherein x is in the range of [0, 130].
c. In one example, when the DDIPM is applied to luma, one or more derived IPMs may be added to the chroma intra prediction mode candidate list as additional and/or replaced modes.
2. When DDIPM is applied to chroma, it is proposed that the derived intra prediction mode (IPM) at decoder for chroma components may be used to construct the chroma intra prediction mode candidate list.
a. In one example, the derived IPM may be added in the chroma intra prediction mode candidate list as an additional mode.
i. In one example, the derived IPM may be added at the first position or the last position of the candidate list.
ii. In one example, the derived IPM may be added before or after an existing chroma mode.
1) In one example, the existing chroma mode may refer to one of CCLM modes, or one of MMLM modes, or the chroma DM mode, or one of the pre-defined traditional intra prediction modes (e.g., Planar, DC, horizontal mode, vertical mode).
b. In one example, the derived IPM may be added in the chroma intra prediction mode candidate list as a replaced mode.
i. In one example, the chroma DM mode is replaced by the derived IPM.
ii. In one example, one of the pre-defined IPMs may be replaced by the derived IPM.
1) For example, the Planar mode, or DC mode, or horizontal mode, or vertical mode, or diagonal mode, or vertical diagonal mode may be replaced by the derived IPM.
iii. In one example, one of the CCLM or MMLM modes may be replaced by the derived IPM.
c. In one example, when more than one IPMs are derived for chroma components, one or more of the derived IPMs may be added as additional/replaced modes in the chroma intra prediction mode candidate list.
d. In one example, how to construct the chroma intra prediction mode candidate list may be different for the two chroma components.
e. In one example, the order of modes excluding the derived IPM in the chroma IPM candidate list with the derived IPM and without the derived IPM may be different.
i. Alternatively, the order of modes excluding the derived IPM in the chroma IPM candidate list with the derived IPM and without the derived IPM may be the same.

### Indication of Intra Prediction Mode Derivation for Chroma Components

3. Indication of the DDIPM_CHROMA mode may be derived on-the-fly.
a. In one example, if the current chroma block is not coded with the linear model mode (e.g., including CCLM, MMLM), the DDIPM_CHROMA mode may be inferred to be used.
4. Indication of the DDIPM_CHROMA mode may be conditionally signalled wherein the condition may include:
a. whether DDIPM_CHROMA for luma is allowed
b. block dimensions and/or block size
c. block depth
d. slice/picture type and/or partition tree type (single, or dual tree, or local dual tree)
e. block location
f. colour component
5. Whether current block is coded with DDIPM_CHROMA mode may be signalled using one or more syntax elements.
a. In one example, the indication of DDIPM_CHROMA for two chroma components such as Cb and Cr may be signalled as one syntax element, or may be signalled as two syntax elements.
i. In one example, whether to apply DDIPM_CHROMA on two chroma components such as Cb and Cr may be controlled together, or may be controlled in a separate way.
b. In one example, the syntax element may be binarized with fixed length coding, or truncated unary coding, or unary coding, or EG coding, or coded a flag.
c. In one example, the syntax element may be bypass coded or context coded.
i. The context may depend on coded information, such as block dimensions, and/or block size, and/or slice/picture types, and/or the information of neighbouring blocks (adjacent or non-adjacent), and/or the information of other coding tools used for current block, and/or the information of temporal layer.
d. In one example, the syntax element may be signalled before or after the indication of colour space conversion, or indication of CCLM and/or MMLM, or indication of conventional intra prediction modes, or chroma DM mode.
e. In one example, one of current syntax element may be replaced to indicate whether DDIPM_CHROMA mode is used for the current block.
i. In one example, one of the syntax elements indicating conventional intra prediction modes may be replaced.
1) In one example, the syntax indicates Planar, or horizontal mode, or vertical mode, or DC mode, or chroma DM may be replaced.
2) In one example, the syntax indicates one of CCLM or MMLM modes may be replaced.
f. In one example, whether a block is allowed to be coded with DDIPM_CHROMA mode may depend on one or more syntax elements.
i. In one example, the one or more syntax elements may be signalled as general constraints information.
1) In one example, when a syntax element (e.g., gci_no_ddipm_chroma_constraint_flag) indicating general constraint on DDIPM_CHROMA is equal to X (e.g., X=0 or X=1), DDIPM_CHROMA shall be not allowed.
2) In one example, when either a syntax element (e.g., gci_no_ddipm_constraint_flag or gci_no_ddipm_constraint_flag) indicating general constraint on DDIPM for Luma is equal to X1 (e.g., X1=0 or X1=1).
ii. In one example, the one or more syntax elements may be signalled at sequence header/picture header/SPS/VPS/DPS/DCI/PPS/APS/slice header/tile group header.
   Determination of Intra Prediction Mode for Chroma Components when its Collocated Luma Block is DDIPM
6. It is proposed that the IPM used in intra prediction for chroma components may depend on whether its collocated luma block is coded with DDIPM or not.
a. In one example, when the collocated luma block is coded with DDIPM and the IPM of luma is in the range of extended angular modes (e.g., mode index in [0, 130]), the IPM of luma may be mapped to conventional range of IPMs (e.g., mode index in [0, 66]) and used as the derived mode for chroma.
i. Alternatively, the IPM of luma is used as the derived mode without mapping to conventional range.
b. In one example, when the collocated luma block is coded with DDIPM, the chroma derived mode is always used in intra prediction for chroma.
i. In one example, the signalling of colour space conversion, and/or CCLM, and/or MMLM, and/or conventional IPMs is skipped.
ii. Alternatively, when the collocated luma block is coded with DDIPM, the intra prediction for chroma may use colour space conversion, or CCLM, or MMLM, or chroma DM.
1) In one example, in this case, the signalling of conventional IPMs is skipped.

### Removal of Division and Floating Point Operation in Fusion Method of TIMD

7. Instead of using a constant cost factor (i.e., 2) in current design of TIMD with fusion, it is proposed to use an adaptive cost factor, wherein the cost factor may be dependent on the coding information.
a. In one example, the coding information may refer to quantization parameter, and/or slice type, and/or block size, etc.
8. In the fusion process of intra-prediction for luma or chroma, the final prediction may be derived as P=W1×P1+W2×P2+ . . . +Wk×Pk in the fusion process, wherein W1+W2+ . . . +Wk=1. P1, P2, . . . . Pk represent the prediction value generated by k IPMs.
a. In an integer form, P=Shift (W1×P1+W2×P2+ . . . +Wk×Pk, s), wherein W1, W2, . . . , Wk are integers and W1+W2+ . . . +Wk=1<<s.
b. In one example, W1, W2, . . . , Wk may depend on sample positions.
c. In one example, W1, W2, . . . , Wk may depend on at least one of the k IPMs.
d. In one example, W1, W2, . . . , Wk may depend on at least one cost for the k IPMs.
9. In current design of TIMD with fusion, the weights for two IPMs are derived using division operation and floating point. Instead of this, it is proposed to derive the weights for the two IPMs using a look-up table or one or multiple equations.
a. In one example, the costs of the two IPMs may be modified before deriving the weights using the look-up table.
i. In one example, shift operation with/without an offset may be used in the modification.
b. Alternatively, the weights may be derived using the same way as derivation of linear parameters in CCLM and/or MMLM.
i. One example of deriving the weights is shown as Embodiment 1.
10. In above examples, the adaptive cost factor and/or how to remove the division operation may be applied to DDIPM (e.g., DIMD).

### General Claims

11. Whether to and/or how to apply the disclosed methods above may be signalled at sequence level/group of pictures level/picture level/slice level/tile group level, such as in sequence header/picture header/SPS/VPS/DPS/DCI/PPS/APS/slice header/tile group header.
12. Whether to and/or how to apply the disclosed methods above may be signalled at PB/TB/CB/PU/TU/CU/VPDU/CTU/CTU row/slice/tile/sub-picture/other kinds of region contains more than one sample or pixel.
13. Whether to and/or how to apply the disclosed methods above may be dependent on coded information, such as block size, colour format, single/dual tree partitioning, colour component, slice/picture type.
14. The proposed methods disclosed in this document may be used to generate intra prediction in other coding tools which require an intra prediction signal (e.g., the CIIP mode).

### 5.1. EMBODIMENT

### 5.1.1. Embodiment 1

An example of deriving weights in TIMD with fusion.

x=Floor(Log 2(costMode1+costMode2))

normDiff=(((costMode1+costMode2)<<4)>>x) & t

x+=(normDiff!=0)?1:0

y=Abs(costMode2)>0?Floor(Log 2(Abs(costMode2)))+1:0

weight1=(costMode2*(divSigTable[normDiff]|8)+2^{y-1})>>y

k=((3+x−y)<1)?1:3+x−y

weight1=((3+x−y)<1)?Sign(weight1)*t: weight1
where divSigTable[ ] is specified as follows:
divSig Table [ ]={d0, d1, d2, d3, d4, d5, d6, d7, d8, d9, d10, d11, d12, d13, d14, d15}

In one example, t=15, divSigTable [ ]={0, 7, 6, 5, 5, 4, 4, 3, 3, 2, 2, 1, 1, 1, 1, 0}

### 5.1.2. Embodiment 2

The cost factor used to determine whether to use the fusion method in intra prediction of current block may be dependent on block size and/or block dimensions. When costMode2<s′ costMode1, the fusion method is used; otherwise, the first derived IPM is used. Denote the block width and block height as W and H.

In one example, when W H is larger than T1, s is equal to S1; Otherwise, s is equal to S2, wherein S1 and S2 are not the same, such as S1=3 and S2=2, or S1=2 and S2=3, or S1=1.8 and S2=2, or S1=2.2 and S2=1.8.

In one example, when W is larger than T1, s is equal to S1; Otherwise, s is equal to S2, wherein S1 and S2 are not the same, such as S1=3 and S2=2, or S1=2 and S2=3, or S1=1.8 and S2=2, or S1=2.2 and S2=1.8.

In one example, when H is larger than T1, s is equal to S1; Otherwise, s is equal to S2, wherein S1 and S2 are not the same, such as S1=3 and S2=2, or S1=2 and S2=3, or S1=1.8 and S2=2, or S1=2.2 and S2=1.8. In one example, when W/H (or H/W) is larger than T1, s is equal to S1; Otherwise, s is equal to S2, wherein S1 and S2 are not the same, such as S1=3 and S2=2, or S1=2 and S2=3, or S1=1.8 and S2=2, or S1=2.2 and S2=1.8.

In one example, when Min (W, H) or Max (W, H) is larger than T1, s is equal to S1; Otherwise, s is equal to S2, wherein S1 and S2 are not the same, such as S1=3 and S2=2, or S1=2 and S2=3, or S1=1.8 and S2=2, or S1=2.2 and S2=1.8.

### 5.1.3. Embodiment 3

The cost factor used to determine whether to use the fusion method in intra prediction of current block may be dependent on quantization parameters (QP). When costMode2<s′ costMode1, the fusion method is used; otherwise, the first derived IPM is used.

In one example, when QP is larger than T1, s is equal to S1; Otherwise, s is equal to S2, wherein S1 and S2 are not the same, such as T1=30, S1=3 and S2=2, or S1=2 and S2=3, or S1=1.8 and S2=2, or S1=2.2 and S2=1.8.

### 5.1.4. Embodiment 4

The cost factor used to determine whether to use the fusion method in intra prediction of current block may be dependent on slice type. When costMode2<s′ costMode1, the fusion method is used; otherwise, the first derived IPM is used.

In one example, when the current slice is I-slice, s is equal to S1; When current slice is P/B slice, s is equal to S2, wherein S1 and S2 are not the same, such as S1=3 and S2=2, or S1=2 and S2=3, or S1=1.8 and S2=2, or S1=2.2 and S2=1.8.

As used herein, the term “block” used herein may refer to one or more of: a color component, a sub-picture, a slice, a tile, a coding tree unit (CTU), a CTU row, a group of CTUs, a coding unit (CU), a prediction unit (PU), a transform unit (TU), a coding tree block (CTB), a coding block (CB), a prediction block (PB), a transform block (TB), a block, a sub-block of a block, a sub-region within the block, or a region that comprises more than one sample or pixel.

In this disclosure, the term decoder-side derivation of intra prediction mode (DDIPM) represents a coding tool that derives intra prediction mode using previously decoded blocks/samples. In one example, the DDIPM could also be interpreted to a decoder-side intra mode derivation (DIMD) method or a template-based intra prediction mode (TIMD) method.

The term “fusion” used herein means using multiple predicted signals to get the final predicted signal for a video unit, in which each predicted signal is generated using one intra prediction mode. The terms “a fusion of multiple predicted signals” or “fusing the multiple predicted signals” used herein means using multiple predicted signals (including a basic predicted signal and one or more additional predicted signal; or including multiple additional predicted signals but without basic predicted signal) to get the final predicted signal for a block.

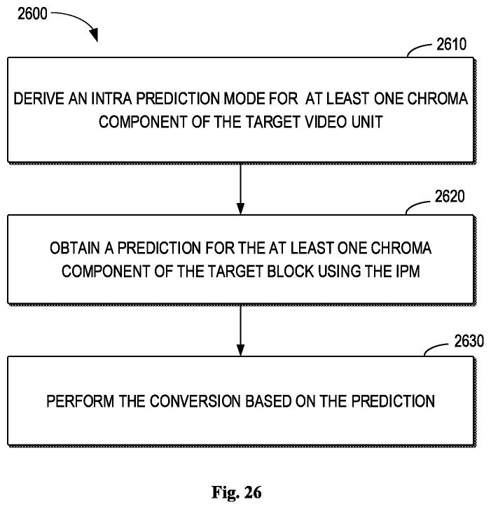

FIG. 26 illustrates a flowchart of a method 2600 for video processing in accordance with some embodiments of the present disclosure. The method 2600 may be implemented during a conversion between a block and a bitstream of the block.

At block 2610, during a conversion between a target unit of a video and a bitstream of the target unit, an intra prediction mode (IPM) for the at least one chroma component of the target unit is derived. The target unit is applied with a target coding tool. In some embodiments, the target coding tool may derive the intra prediction mode using previously decoded blocks or decoded samples. For example, the target coding tool may comprise one of: a decoder-side derivation of intra prediction mode (DDIPM), a decoder-side intra mode derivation (DIMD) method, or a templated based intra prediction mode (TIMD) method. In some embodiments, the coded mode of the block may be denoted as DDIPM_CHROMA.

At block 2620, a prediction for the at least one chroma component of the target unit is obtained using the IPM. In other words, a reconstruction of the target unit for the at least one chroma component may be obtained using the IPM.

At block 2630, the conversion is performed based on the prediction. In some embodiments, the conversion may comprise encoding the video unit into the bitstream. In some embodiments, the conversion may comprise decoding the video unit from the bitstream.

According to embodiments of the present disclosure, compression efficiency can be improved, especially in the low bit rate scenarios. Compared with the conventional solution, embodiments of the present disclosure can advantageously improve the coding efficiency. Moreover, embodiments of the present disclosure can be hardware-friendly.

Implementations of the present disclosure can be described in view of the following clauses, the features of which can be combined in any reasonable manner.

In some embodiments, a template used to derive the IPM may comprise at least one of: a first set of neighboring adjacent reconstructed samples, a second set of neighboring adjacent reconstructed pixels, a third set of neighboring non-adjacent reconstructed samples, or a fourth set of neighboring non-adjacent reconstructed pixels.

In some embodiments, the template may comprise at least one of: a template comprising a set of neighboring left-above reconstructed samples of the target unit, a template comprising a set of neighboring left reconstructed samples, a template comprising a set of neighboring above reconstructed samples, a template comprising a set of neighboring left-below reconstructed samples, or a template comprising a set of neighboring right-above reconstructed samples. For example, the template may comprise one of: “Template-LA” (for example, as shown in FIG. 25a), “Template-L” (for example, as shown in FIG. 25d), “Template-A” (for example, FIG. 25c), “Template-LB” or “Template-RA.”

In some other embodiments, the template may comprise combined neighbouring reconstructed samples from left-above, and/or left, and/or above, and/or left-below, and/or right-above reconstructed samples. In one example, the template may consist of “Template-L” and “Template-A”, such as example shown in FIG. 25b. In one example, the template may comprise “Template-L” and “Template-LB”, such as an example shown in FIG. 25e. In one example, the template may comprise “Template-A” and “Template-RA”, such as an example shown in FIG. 25f. In one example, the template may comprise “Template-A”, “Template-L”, “Template-LB”, and “Template-RA”, such as an example shown in FIG. 25g. In one example, the template may comprise “Template-LA”, “Template-A”, “Template-L”, “Template-LB”, and “Template-RA”, such as an example shown in FIG. 25h. In one example, the template may be non-adjacent, such as an example shown in FIG. 25i and FIG. 25j.

In some other embodiments, the template used to derive the IPM may comprise at least one of: a set of neighboring left-above reconstructed samples of the target unit, a set of neighboring left reconstructed samples, a set of neighboring above reconstructed samples, a set of neighboring left-below reconstructed samples, or a set of neighboring right-above reconstructed samples. In some other embodiments, the template used to derive the IPM may be non-adjacent.

In some other embodiments, the template may comprise a set of samples of a first component, and the template may be used to derive the IPM for the first component. For example, the first component may be one of Cb or Cr.

In some embodiments, the template may comprise a set of samples of a first component, and the template may be used to derive the IPM for a second component. For example, the first component may be Cb and the second component may be Cr. Alternatively, the first component may be Y and the second component may be Cr. In some embodiments, the first component may comprise more than one component, and the second component may comprise more than one component. For example, the first component may be Cb and Cr, and the second component may be Cb and Cr. In some embodiments, the first component may be Y and the second components may be Cb and Cr. Alternatively, the first component may be Y and the second component may be Cb.

In some embodiments, during a derivation of the IPM for the at least one chroma component, an intra prediction may be processed on a first template using one of IPMs from a first IPM candidate list. In this case, a candidate IPM with a minimum cost may be derived as the IPM for the at least one chroma component.

In some embodiments, the derivation of the IPM for the at least one chroma component may be same as a derivation of an IPM for a luma component. In an example embodiment, a first template (for example, shape/size) used for the derivation of the IPM for the at least one chroma component may be same as a second template used for the derivation of the IPM for the luma component. In one example embodiment, the first IPM candidate list used for the derivation of the IPM for the at least one chroma component may be same as a second IPM candidate list for the derivation of the IPM for the luma component. In another example embodiment, a first cost used for the derivation of the IPM for the at least one chroma component may be calculated in same way as calculating a second cost used for the derivation of the IPM for the luma component. In other words, how to calculate the cost used to derive the IPM for chroma may be same as luma.

In some embodiments, a parameter associated with the first template used for the derivation of the at least one chroma component may be different from a parameter associated with a second template used for a derivation of a luma component. For example, the parameter associated with the first template may comprise at least one of: a template shape, a template size, or a template dimension.

In some embodiments, the parameter associated with the first template depends on the parameter associated with the second template. In some embodiments, a first template shape of the first template may be obtained by: S1=S2/(SubWidth′SubHeight), and where S1 represents the first template shape of the first template, S2 represents a second template shape of the second template, SubWidth represents a width variable depending on a chroma format sampling structure, and SubHeight represents a height variable depending on the chroma format sampling structure.

In some embodiments, a first template width of the first template may be obtained by: W1=W2/SubWidth, and where W1 represents the first template width of the first template, W2 represents a second template width of the second template, and SubWidth represents a width variable depending on a chroma format sampling structure.

In some embodiments, a first template height of the first template may be obtained by: H1=H2/SubHeight, and where H1 represents the first template height of the first template, H2 represents a second template height of the second template, and SubHeight represents a height variable depending on the chroma format sampling structure. The above SubWidthC and SubHeightC may be defined in Table 2-1 shown as above.

In some embodiments, the first IPM candidate list for the derivation of the IPM for the at least one chroma component may be different from a second IPM candidate list for a derivation of an IPM for a luma component. In an example embodiment, the first IPM candidate list comprises at least one of: one or more IPMs which is explicitly indicated in an intra prediction mode, or one or more extended angular IPMs. For example, the first IPM candidate list for chroma may consist of one or more IPMs that can be signalled explicitly in the conventional intra prediction modes (e.g., 35 IPMs in HEVC, or 67 IPMs in VVC), and/or one or more extended angular IPMs as shown in FIG. 24. In an example embodiment, a first number of IPMs in the first IPM candidate list may be less than a second number of IPMs in the second IPM candidate list. In an example embodiment, the first IPM candidate list may comprise one or more cross-component prediction modes. For example, the first IPM candidate list for chroma may consist of cross-component prediction mode such as LM, and/or LM_T, and/or LM_L, and/or MMLM, and/or MMLM_T, and/or MMLM_L.

In some embodiments, a first target IPM from the first IPM candidate list may be derived in a different way as deriving a second target IPM for a luma component. In other words, how to derive the optimal IPM from the IPM candidate list for chroma may be different from luma. In one example, at least part of IPMs may be used in an intra prediction for the first template during the derivation of the IPM for the at least one chroma component. For example, partial or all IPMs may be used/checked in the intra prediction for the template during the derivation of the IPM for chroma.

In some embodiments, an early termination approach may be used during the derivation of the IPM for the at least one chroma component. In one example, if a cost of a candidate IPM in the first IPM candidate list is less than a threshold, the candidate IPM may be determined as the IPM for the at least one chroma component and remaining unchecked IPMs in the first IPM candidate may be skipped. In this case, in some embodiments, the threshold may be one of: pre-defined, indicated in the bitstream, or dependent on coding information of target unit. In an example, the threshold may depend on the number of IMPs in the first IPM candidate list that have been checked. Alternatively, the threshold may depend on costs of IPMs that have been checked.

In some embodiments, IPMs in the first IPM candidate list may be reordered during the derivation of the IPM for the at least one chroma component. In some embodiments, whether to check next one or more IPMs in the first IPM candidate list may depend on costs of IPMs that have been checked. Alternatively, or in addition, how to check the next one or more IPMs in the first IPM candidate list may depend on costs of IPMs that have been checked.

In some embodiments, a sum of an absolute transformed difference (SATD) between predicted samples and reconstructed samples of the first template may be calculated and used to derive a cost associated with the target unit.

In some embodiments, at least one of the followings is calculated and used to derive a cost associated with the target unit: a sum of squared errors (SSE) between predicted samples of the first template and reconstructed samples of the first template, a sum of absolute difference (SAD) between the predicted samples of the first template and the reconstructed samples of the first template, a mean removal sum of absolute difference (MRSAD) between the predicted samples of the first template and the reconstructed samples of the first template, a subjective quality metric between the predicted samples of the first template and the reconstructed samples of the first template, or a structural similarity index measure (SSIM) between the predicted samples of the first template and the reconstructed samples of the first template.

In an example embodiment, the cost may be calculated in a form of D+2′ R, where D represents a metric of distortion, R represents the number of bits under consideration and 2 represents a pre-defined factor or a factor derived on-the-fly. In an example embodiment, at least a part of samples of the first template may be used to calculate the cost.

In some embodiments, both of two chroma components may be used to calculate the cost. In some embodiments, the two chroma components may comprise Cb component and Cr component in YCbCr colour format. Alternatively, the two chroma components may comprise blue (B) component and red (R) component in RedGreenBlue (RGB) colour format.

In some embodiments, a total cost of the two chroma components may be obtained by: C=C1+C2, and where C represents the total cost, C1 represents a first cost of a first chroma component in the two chroma components, and C2 represents a second cost of a second chroma component in the two chroma components. In some embodiments, a total cost of the two chroma components may be obtained by: C=w1′C1+w2′C2, and where C represents the total cost, C1 represents a first cost of a first chroma component in the two chroma components, C2 represents a second cost of a second chroma component in the two chroma components, w1 represents a first weighted factor for the first chroma, and w2 represents a second weighted factor for the second chroma. In an example embodiment, the first weighted factor may be obtained by w1=1−w2.

In some embodiments, a total cost of the two chroma components may be obtained by: C=(w1′C1+w2′ C2+offset)>>shift, and where C represents the total cost, C1 represents a first cost of a first chroma component in the two chroma components, C2 represents a second cost of a second chroma component in the two chroma components, w1 represents a first weighted factor for the first chroma, w2 represents a second weighted factor for the second chroma, and offset and shift represent integers, respectively. For example, Shift (x, n) may be defined as Shift (x, n)=(x+offset0)>>n. In one example, offset0 and/or offset1 may be set to (1<<n)>>1 or (1<< (n−1)). In another example, offset0 and/or offset1 may be set to 0. In another example, offset0=offset1=((1<<n)>>1)−1 or ((1<<(n−1)))−1. In some embodiments, w1 may be one of: indicated in the bitstream, predefined, derived on-the-fly, or dependent on coding information, w2 may be one of: indicated in the bitstream, predefined, derived on-the-fly, or dependent on coding information, offset may be one of: indicated in the bitstream, predefined, derived on-the-fly, or dependent on coding information, or shift may be one of: indicated in the bitstream, predefined, derived on-the-fly, or dependent on coding information.

In some embodiments, reference samples used in an intra prediction for the first template during the derivation of the IPM for the at least one chroma component may be unfiltered. Alternatively, reference samples used in an intra prediction for the first template during the derivation of the IPM for the at least one chroma component may be filtered using a same way as one of the followings: an intra prediction for chroma component, an intra prediction for luma component, or a derivation of an IPM for a luma component.

In some embodiments, a filtering method used to refine a predicted signal of intra prediction for the target unit may be used during the derivation of the IPM for the at least one chroma component. In one example, the filtering method used to refine the predicted signal of intra prediction for the block (e.g., PDPC or gradient PDPC) may be used during the derivation of the IPM for chroma.

In some embodiments, whether to apply a filtering method used to refine a predicted signal of intra prediction for the target unit may in a same way as one of: an intra prediction for chroma component, an intra prediction for luma component, or a derivation of an IPM for a luma component. Alternatively, or in addition, how to apply a filtering method used to refine a predicted signal of intra prediction for the target unit may be in a same way as one of: an intra prediction for chroma component, an intra prediction for luma component, or a derivation of an IPM for a luma component.

In some embodiments, a first interpolation filter used in an intra prediction for the first template during the derivation of the IPM for the at least one chroma component may be same as a second interpolation filter. In this case, the second interpolation filter may be used in at least one of: an intra prediction for chroma component, an interpolation filter used in intra prediction for luma component, an interpolation filter used in the intra prediction for the first template during a derivation of an IPM for the luma component.

In some embodiments, a first interpolation filter used in an intra prediction for the first template during the derivation of the IPM for the at least one chroma component may be different from a second interpolation filter. In this case, the second interpolation filter may be used in at least one of: an intra prediction for chroma component, an interpolation filter used in intra prediction for luma component, an interpolation filter used in the intra prediction for the first template during a derivation of an IPM for the luma component.

In some embodiments, a first mode conversion process for extended IPMs in the derivation of the IPM for the at least one chroma component may be same as a second mode conversion process for extended IPMs used in intra prediction for chroma. In some embodiments, the first mode conversion process may be different from the second mode conversion process.

In some embodiments, a third mode conversion process for extended IPMs in a derivation of an IPM for a luma component may be same as a fourth mode conversion process for extended IPMs used in intra prediction for luma. Alternatively, the third mode conversion process may be different from the fourth mode conversion process.

In some embodiments, a histogram of gradients (HoG) may be built using samples/pixels in a first template used to derive the IPM, each bin in the HoG is mapped to one IPM. In this case, a candidate IPM with a highest amplitude may be used as the IPM for the at least one chroma component.

In some embodiments, a derivation of the IPM for the at least one chroma component may be same as a derivation of an IPM for a luma component. In other words, the derivation of the IPM for chroma (e.g., how to build the HoG, or the number of bins in the HoG, or how to map the bins to IPMs) may be same as luma.

In some embodiments, a parameter associated with the first template may be different from a parameter associated with a second template used in calculating gradients for a luma component. In this case, in some embodiments, the parameter associated with the first template may comprise at least one of: a template shape, a template size, or a template dimension. Alternatively, a first ratio of template size for chroma compared to luma may follow a second ratio due to colour formats.

In some embodiments, a calculation of gradients for chroma may be different from a calculation of gradients for luma. In one example embodiment, one of the followings may be used for the calculation of gradients for chroma: a Sobel operator, an Isotropic Sobel operator, a Roberts operator, a Prewitt operator, a Laplacian operator, or a Canny operator.

In some embodiments, the number of bins in the HoG may be equal to the number of IPMs that is explicitly indicated. Alternatively, the number of bins in the HoG may be less than the number of IPMs that is explicitly indicated. In some embodiments, both chroma components may be used to calculate gradients for chroma.

In some embodiments, one of chroma components may be used to derive the IPM. In other words, only one of the chroma components (e.g., Cb or Cr in YCbCr colour format, or B or R in RGB colour format) may be used to derive the IPM (e.g., calculate the cost or calculate the gradients). In an example embodiment, which chroma component is used may be indicated in the bit stream. In an example embodiment, which chroma component is used may be predefined. In an example embodiment, which chroma component is may be determined on-the-fly. In an example embodiment, which chroma component is used may be dependent on coding information. In an example embodiment, a derivation for the IPM may be used in an intra prediction for the chroma components of the target unit.

In some embodiments, a target IPM may be derived for each chroma component individually. In other words, an IPM is derived using above methods for each chroma component individually. In an example embodiment, a derivation of the target IPM may be different for different chroma components. In an example embodiment, the derived target IPM for different chroma components may be different. In an example embodiment, the derived target IPM for chroma different chroma components may the same.

In some embodiments, a fusion of predicted signals which are generated by a plurality of IPMs may be used as a final prediction for chroma components of the target unit. In some embodiments, the plurality of IPMs may comprise at least one of: one or more derived IPMs, one or more predefined prediction modes, or one or more indicated prediction modes. In an example embodiment, the one or more predefined prediction modes may comprise a cross-component prediction mode. For example, the pre-defined modes may be cross-component prediction mode such as LM, and/or LM_T, and/or LM_L, and/or MMLM, and/or MMLM_T, and/or MMLM_L. Alternatively, the one or more indicated prediction modes may comprise a cross-component prediction mode. In an example embodiment, the one or more predefined prediction modes may comprise at least one of: a planar mode, a direct currency (DC) mode, a horizontal mode, a vertical mode, a diagonal mode, or a vertical diagonal mode. In an example embodiment, the one or more indicated prediction modes may comprise at least one of: a planar mode, a direct currency (DC) mode, a horizontal mode, a vertical mode, a diagonal mode, or a vertical diagonal mode.

In some embodiments, different approaches for the fusion may be used. In this case, the different approaches may comprise at least one of: different IPMs in the fusion, or different weighted factors in the fusion. In some embodiments, weighted factors may be dependent on a cost or amplitude during a derivation of the plurality of IPMs.

In some embodiments, whether to and/or how to fuse the predicted signals may be one of: indicated in the bitstream, determined on-the-fly, or dependent on coding information. In some embodiments, the number of IPMs used in the fusion of the predicted signals may be one of: indicated in the bitstream, determined on-the-fly, or dependent on coding information. In some embodiments, whether to and/or how to apply a fusion method of the predicted signals may be dependent on costs or amplitudes of the plurality of IPMs. In an example embodiment, if a second cost of a second best derived IPM is less than a first cost of a best derived IPM multiplying a cost factor, the fusion method may be applied. For example, denote the cost of the best derived IPM as Cost1, and the cost the second best derived IPM as Cost2, when Cost2 is less than T′Cost1, the fusion method may be applied, wherein T is a cost factor.

In some embodiments, a plurality of IPMs may be derived. In this case, which IPM is used in an intra prediction for chroma components may be at least one of: indicated in the bitstream, determined on-the-fly, or dependent on coding information.

In some embodiments, an indication of whether to and/or how to derive the IPM for the target unit may be indicated at one of the followings: sequence level, group of pictures level, picture level, slice level, or tile group level.

In some embodiments, an indication of whether to and/or how to derive the IPM for the target unit may be indicated in one of the following: a sequence header, a picture header, a sequence parameter set (SPS), a video parameter set (VPS), a dependency parameter set (DPS), a decoding capability information (DCI), a picture parameter set (PPS), an adaptation parameter sets (APS), a slice header, or a tile group header.

In some embodiments, an indication of whether to and/or how to derive the IPM for the target unit may be included in one of the following: a prediction block (PB), a transform block (TB), a coding block (CB), a prediction unit (PU), a transform unit (TU), a coding unit (CU), a virtual pipeline data unit (VPDU), a coding tree unit (CTU), a CTU row, a slice, a tile, a sub-picture, or a region containing more than one sample or pixel.

In some embodiments, whether to and/or how to derive the IPM for the target unit may be determined based on coded information of the target unit. The coded information may include at least one of: a block size, a colour format, a single and/or dual tree partitioning, a colour component, a slice type, or a picture type.

In some embodiments, a bitstream of a video may be stored in a non-transitory computer-readable recording medium. The bitstream of the video can be generated by a method performed by a video processing apparatus. According to the method, an intra prediction mode (IPM) of the target unit for at least one chroma component may be derived. The target unit is applied with a target coding tool. A prediction of the target unit for the at least one chroma component may be obtained using the IPM. A bitstream of the target unit may be generated based on the prediction.

In some embodiments, an intra prediction mode (IPM) of the target unit for at least one chroma component may be derived. The target unit is applied with a target coding tool. A prediction of the target unit for the at least one chroma component may be obtained using the IPM. A bitstream of the target unit may be generated based on the prediction and stored in a non-transitory computer-readable recording medium.

Embodiments of the present disclosure can be implemented separately. Alternatively, embodiments of the present disclosure can be implemented in any proper combinations. Implementations of the present disclosure can be described in view of the following clauses, the features of which can be combined in any reasonable manner.

Clause 1. A method of video processing, comprising: deriving, during a conversion between a target unit of a video and a bitstream of the target unit, an intra prediction mode (IPM) for at least one chroma component of the target unit, the target unit being applied with a target coding tool; obtaining a prediction for the at least one chroma component of the target unit using the IPM; and performing the conversion based on the prediction.

Clause 2. The method of clause 1, wherein the target coding tool derives the intra prediction mode using previously decoded blocks or decoded samples, and wherein the target coding tool comprises one of: a decoder-side derivation of intra prediction mode (DDIPM), a decoder-side intra mode derivation (DIMD) method, or a templated based intra prediction mode (TIMD) method.

Clause 3. The method of clause 1, wherein a template used to derive the IPM comprises at least one of: a first set of neighboring adjacent reconstructed samples, a second set of neighboring adjacent reconstructed pixels, a third set of neighboring non-adjacent reconstructed samples, or a fourth set of neighboring non-adjacent reconstructed pixels.

Clause 4. The method of clause 3, wherein the template comprises at least one of: a template comprising a set of neighboring left-above reconstructed samples of the target unit, a template comprising a set of neighboring left reconstructed samples, a template comprising a set of neighboring above reconstructed samples, a template comprising a set of neighboring left-below reconstructed samples, or a template comprising a set of neighboring right-above reconstructed samples.

Clause 5. The method of clause 1, wherein a template used to derive the IPM comprises at least one of: a set of neighboring left-above reconstructed samples of the target unit, a set of neighboring left reconstructed samples, a set of neighboring above reconstructed samples, a set of neighboring left-below reconstructed samples, or a set of neighboring right-above reconstructed samples.

Clause 6. The method of clause 1, wherein a template used to derive the IPM is non-adjacent.

Clause 7. The method of clause 3, wherein the template comprises a set of samples of a first component, and the template is used to derive the IPM for the first component.

Clause 8. The method of clause 7, wherein the first component is one of Cb or Cr.

Clause 9. The method of clause 3, wherein the template comprises a set of samples of a first component, and the template is used to derive the IPM for a second component.

Clause 10. The method of clause 9, wherein the first component is Cb and the second component is Cr, wherein the first component is Y and the second components are Ch and Cr, or wherein the first component is Y and the second component is Cb, or wherein the first component is Y and the second component is Cr.

Clause 11. The method of clause 9, wherein the first component comprises more than one component, and the second component comprises more than one component.

Clause 12. The method of clause 1, wherein during a derivation of the IPM for the at least one chroma component, an intra prediction is processed on a first template using one of IPMs from a first IPM candidate list, and a candidate IPM with a minimum cost is derived as the IPM for the at least one chroma component.

Clause 13. The method of clause 12, wherein the derivation of the IPM for the at least one chroma component is same as a derivation of an IPM for a luma component.

Clause 14. The method of clause 13, wherein a first template used for the derivation of the IPM for the at least one chroma component is same as a second template used for the derivation of the IPM for the luma component.

Clause 15. The method of clause 13, wherein the first IPM candidate list used for the derivation of the IPM for the at least one chroma component is same as a second IPM candidate list for the derivation of the IPM for the luma component.

Clause 16. The method of clause 13, wherein a first cost used for the derivation of the IPM for the at least one chroma component is calculated in same way as calculating a second cost used for the derivation of the IPM for the luma component.

Clause 17. The method of clause 12, wherein a parameter associated with the first template used for the derivation of the at least one chroma component is different from a parameter associated with a second template used for a derivation of a luma component.

Clause 18. The method of clause 17, wherein the parameter associated with the first template comprises at least one of: a template shape, a template size, or a template dimension.

Clause 19. The method of clause 17, wherein the parameter associated with the first template depends on the parameter associated with the second template.

Clause 20. The method of clause 19, wherein a first template shape of the first template is obtained by: S1=S2/(SubWidth′SubHeight), and where S1 represents the first template shape of the first template, S2 represents a second template shape of the second template, SubWidth represents a width variable depending on a chroma format sampling structure, and SubHeight represents a height variable depending on the chroma format sampling structure.

Clause 21. The method of clause 19, wherein a first template width of the first template is obtained by: W1=W2/SubWidth, and where W1 represents the first template width of the first template, W2 represents a second template width of the second template, and SubWidth represents a width variable depending on a chroma format sampling structure.

Clause 22. The method of clause 19, wherein a first template height of the first template is obtained by: H1=H2/SubHeight, and where H1 represents the first template height of the first template, H2 represents a second template height of the second template, and SubHeight represents a height variable depending on the chroma format sampling structure.

Clause 23. The method of clause 12, wherein the first IPM candidate list for the derivation of the IPM for the at least one chroma component is different from a second IPM candidate list for a derivation of an IPM for a luma component.

Clause 24. The method of clause 23, wherein the first IPM candidate list comprises at least one of: one or more IPMs which is explicitly indicated in an intra prediction mode, or one or more extended angular IPMs.

Clause 25. The method of clause 23, wherein a first number of IPMs in the first IPM candidate list is less than a second number of IPMs in the second IPM candidate list.

Clause 26. The method of clause 23, wherein the first IPM candidate list comprises one or more cross-component prediction modes.

Clause 27. The method of clause 12, wherein a first target IPM from the first IPM candidate list is derived in a different way as deriving a second target IPM for a luma component.

Clause 28. The method of clause 27, wherein at least part of IPMs is used in an intra prediction for the first template during the derivation of the IPM for the at least one chroma component.

Clause 29. The method of clause 27, wherein an early termination approach is used during the derivation of the IPM for the at least one chroma component.

Clause 30. The method of clause 29, wherein if a cost of a candidate IPM in the first IPM candidate list is less than a threshold, the candidate IPM is determined as the IPM for the at least one chroma component, and remaining unchecked IPMs in the first IPM candidate list are skipped.

Clause 31. The method of clause 30, wherein the threshold is one of: pre-defined, indicated in the bitstream, or dependent on coding information of target unit.

Clause 32. The method of clause 30, wherein the threshold depends on the number of IMPs in the first IPM candidate list that have been checked, or wherein the threshold depends on costs of IPMs that have been checked.

Clause 33. The method of clause 27, wherein IPMs in the first IPM candidate list are reordered during the derivation of the IPM for the at least one chroma component.

Clause 34. The method of clause 27, further comprising at least one of: whether to check next one or more IPMs in the first IPM candidate list depends on costs of IPMs that have been checked, or how to check the next one or more IPMs in the first IPM candidate list depends on costs of IPMs that have been checked.

Clause 35. The method of clause 12, wherein a sum of an absolute transformed difference (SATD) between predicted samples and reconstructed samples of the first template is calculated and used to derive a cost associated with the target unit.

Clause 36. The method of clause 12, wherein at least one of the followings is calculated and used to derive a cost associated with the target unit: a sum of squared errors (SSE) between predicted samples of the first template and reconstructed samples of the first template, a sum of absolute difference (SAD) between the predicted samples of the first template and the reconstructed samples of the first template, a mean removal sum of absolute difference (MRSAD) between the predicted samples of the first template and the reconstructed samples of the first template, a subjective quality metric between the predicted samples of the first template and the reconstructed samples of the first template, or a structural similarity index measure (SSIM) between the predicted samples of the first template and the reconstructed samples of the first template.

Clause 37. The method of clause 36, wherein the cost is calculated in a form of D+λ′R, wherein D represents a metric of distortion, R represents the number of bits under consideration and λ represents a pre-defined factor or a factor derived on-the-fly.

Clause 38. The method of clause 36, wherein at least a part of samples of the first template is used to calculate the cost.

Clause 39. The method of clause 36, wherein both of two chroma components are used to calculate the cost.

Clause 40. The method of clause 39, wherein the two chroma components comprise Cb component and Cr component in YCbCr colour format, or the two chroma components comprise blue (B) component and red (R) component in RedGreenBlue (RGB) colour format.

Clause 41. The method of clause 39, wherein a total cost of the two chroma components is obtained by: C=C1+C2, and wherein C represents the total cost, C1 represents a first cost of a first chroma component in the two chroma components, and C2 represents a second cost of a second chroma component in the two chroma components.

Clause 42. The method of clause 39, wherein a total cost of the two chroma components is obtained by: C=w1′ C1+w2′C2, and wherein C represents the total cost, C1 represents a first cost of a first chroma component in the two chroma components, C2 represents a second cost of a second chroma component in the two chroma components, w1 represents a first weighted factor for the first chroma, and w2 represents a second weighted factor for the second chroma.

Clause 43. The method of clause 42, wherein the first weighted factor is obtained by w1=1−w2.

Clause 44. The method of clause 39, wherein a total cost of the two chroma components is obtained by: C=(w1′C1+w2′C2+offset)>>shift, and wherein C represents the total cost, C1 represents a first cost of a first chroma component in the two chroma components, C2 represents a second cost of a second chroma component in the two chroma components, w1 represents a first weighted factor for the first chroma, w2 represents a second weighted factor for the second chroma, and offset and shift represent integers, respectively.

Clause 45. The method of clause 44, wherein w1 is one of: indicated in the bitstream, predefined, derived on-the-fly, or dependent on coding information, wherein w2 is one of: indicated in the bitstream, predefined, derived on-the-fly, or dependent on coding information, wherein offset is one of: indicated in the bitstream, predefined, derived on-the-fly, or dependent on coding information, or wherein shift is one of: indicated in the bitstream, predefined, derived on-the-fly, or dependent on coding information.

Clause 46. The method of clause 12, wherein reference samples used in an intra prediction for the first template during the derivation of the IPM for the at least one chroma component are unfiltered.

Clause 47. The method of clause 12, wherein reference samples used in an intra prediction for the first template during the derivation of the IPM for the at least one chroma component are filtered using a same way as one of the followings: an intra prediction for chroma component, an intra prediction for luma component, or a derivation of an IPM for a luma component.

Clause 48. The method of clause 12, wherein a filtering method used to refine a predicted signal of intra prediction for the target unit is used during the derivation of the IPM for the at least one chroma component.

Clause 49. The method of clause 12, wherein whether to apply a filtering method used to refine a predicted signal of intra prediction for the target unit is in a same way as one of: an intra prediction for chroma component, an intra prediction for luma component, or a derivation of an IPM for a luma component.

Clause 50. The method of clause 12, wherein how to apply a filtering method used to refine a predicted signal of intra prediction for the target unit is in a same way as one of: an intra prediction for chroma component, an intra prediction for luma component, or a derivation of an IPM for a luma component.

Clause 51. The method of clause 12, wherein a first interpolation filter used in an intra prediction for the first template during the derivation of the IPM for the at least one chroma component is same as a second interpolation filter, and wherein the second interpolation filter is used in at least one of: an intra prediction for chroma component, an interpolation filter used in intra prediction for luma component, an interpolation filter used in the intra prediction for the first template during a derivation of an IPM for the luma component.

Clause 52. The method of clause 12, wherein a first interpolation filter used in an intra prediction for the first template during the derivation of the IPM for the at least one chroma component is different from a second interpolation filter, and wherein the second interpolation filter is used in at least one of: an intra prediction for chroma component, an interpolation filter used in intra prediction for luma component, an interpolation filter used in the intra prediction for the first template during a derivation of an IPM for the luma component.

Clause 53. The method of clause 1, wherein a first mode conversion process for extended IPMs in the derivation of the IPM for the at least one chroma component is same as a second mode conversion process for extended IPMs used in intra prediction for chroma, or wherein the first mode conversion process is different from the second mode conversion process.

Clause 54. The method of clause 1, wherein a third mode conversion process for extended IPMs in a derivation of an IPM for a luma component is same as a fourth mode conversion process for extended IPMs used in intra prediction for luma, or wherein the third mode conversion process is different from the fourth mode conversion process.

Clause 55. The method of clause 1, wherein a histogram of gradients (HoG) is built using samples/pixels in a first template used to derive the IPM, each bin in the HoG is mapped to one IPM, and a candidate IPM with a highest amplitude is used as the IPM for the at least one chroma component.

Clause 56. The method of clause 55, wherein a derivation of the IPM for the at least one chroma component is same as a derivation of an IPM for a luma component.

Clause 57. The method of clause 55, wherein a parameter associated with the first template is different from a parameter associated with a second template used in calculating gradients for a luma component.

Clause 58. The method of clause 57, wherein the parameter associated with the first template comprises at least one of: a template shape, a template size, or a template dimension.

Clause 59. The method of clause 55, wherein a first ratio of template size for chroma compared to luma follows a second ratio due to colour formats.

Clause 60. The method of clause 55, wherein a calculation of gradients for chroma is different from a calculation of gradients for luma.

Clause 61. The method of clause 60, wherein one of the followings is used for the calculation of gradients for chroma: a Sobel operator, an Isotropic Sobel operator, a Roberts operator, a Prewitt operator, a Laplacian operator, or a Canny operator.

Clause 62. The method of clause 55, wherein the number of bins in the HoG is equal to the number of IPMs that is explicitly indicated, or wherein the number of bins in the HoG is less than the number of IPMs that is explicitly indicated.

Clause 63. The method of clause 55, wherein both chroma components are used to calculate gradients for chroma.

Clause 64. The method of clause 1, wherein one of chroma components is used to derive the IPM.

Clause 65. The method of clause 64, wherein which chroma component is used is indicated in the bit stream, or wherein which chroma component is used is predefined, or wherein which chroma component is used is determined on-the-fly, or wherein which chroma component is used is dependent on coding information.

Clause 66. The method of clause 64, wherein a derivation for the IPM is used in an intra prediction for the chroma components of the target unit.

Clause 67. The method of clause 1, wherein a target IPM is derived for each chroma component individually.

Clause 68. The method of clause 67, wherein a derivation of the target IPM is different for different chroma components.

Clause 69. The method of clause 67, wherein the derived target IPM for different chroma components is different.

Clause 70. The method of clause 67, wherein the derived target IPM for chroma different chroma components is the same.

Clause 71. The method of clause 1, wherein a fusion of predicted signals which are generated by a plurality of IPMs is used as a final prediction for the chroma components of the target unit.

Clause 72. The method of clause 71, wherein the plurality of IPMs comprises at least one of: one or more derived IPMs, one or more predefined prediction modes, or one or more indicated prediction modes.

Clause 73. The method of clause 72, wherein the one or more predefined prediction modes comprise a cross-component prediction mode, or wherein the one or more indicated prediction modes comprise a cross-component prediction mode.

Clause 74. The method of clause 72, wherein the one or more predefined prediction modes comprise at least one of: a planar mode, a direct currency (DC) mode, a horizontal mode, a vertical mode, a diagonal mode, or a vertical diagonal mode.

Clause 75. The method of clause 72, wherein the one or more indicated prediction modes comprise at least one of: a planar mode, a direct currency (DC) mode, a horizontal mode, a vertical mode, a diagonal mode, or a vertical diagonal mode.

Clause 76. The method of clause 71, wherein different approaches for the fusion are used, and wherein the different approaches comprise at least one of: different IPMs in the fusion, or different weighted factors in the fusion.

Clause 77. The method of clause 76, wherein weighted factors are dependent on a cost or amplitude during a derivation of the plurality of IPMs.

Clause 78. The method of clause 71, wherein whether to and/or how to fuse the predicted signals is one of: indicated in the bitstream, determined on-the-fly, or dependent on coding information.

Clause 79. The method of clause 71, wherein the number of IPMs used in the fusion of the predicted signals is one of: indicated in the bitstream, determined on-the-fly, or dependent on coding information.

Clause 80. The method of clause 71, wherein an indication of a method for the fusion of the predicted signals is one of: indicated in the bitstream, determined on-the-fly, or dependent on coding information.

Clause 81. The method of clause 71, wherein whether to and/or how to apply a fusion method of the predicted signals is dependent on costs or amplitudes of the plurality of IPMs.

Clause 82. The method of clause 81, wherein if a second cost of a second best derived IPM is less than a first cost of a best derived IPM multiplying a cost factor, the fusion method is applied.

Clause 83. The method of clause 1, wherein a plurality of IPMs is derived, and which IPM is used in an intra prediction for chroma components is at least one of: indicated in the bitstream, determined on-the-fly, or dependent on coding information.

Clause 84. The method of any of clauses 1-83, wherein an indication of whether to and/or how to derive the IPM for the at least one chroma component of the target unit is indicated at one of the followings: sequence level, group of pictures level, picture level, slice level, or tile group level.

Clause 85. The method of any of clauses 1-83, wherein an indication of whether to and/or how to derive the IPM for the at least one chroma component of the target unit is indicated in one of the following: a sequence header, a picture header, a sequence parameter set (SPS), a video parameter set (VPS), a dependency parameter set (DPS), a decoding capability information (DCI), a picture parameter set (PPS), an adaptation parameter sets (APS), a slice header, or a tile group header.

Clause 86. The method of any of clauses 1-83, wherein an indication of whether to and/or how to derive the IPM for the at least one chroma component of the target unit is included in one of the following: a prediction block (PB), a transform block (TB), a coding block (CB), a prediction unit (PU), a transform unit (TU), a coding unit (CU), a virtual pipeline data unit (VPDU), a coding tree unit (CTU), a CTU row, a slice, a tile, a sub-picture, or a region containing more than one sample or pixel.

Clause 87. The method of any of clauses 1-83, further comprising: determining, based on coded information of the target unit, whether and/or how to derive the IPM for the at least one chroma component of the target unit, the coded information including at least one of: the coding mode, a block size, a colour format, a single and/or dual tree partitioning, a colour component, a slice type, or a picture type.

Clause 88. The method clause 1, further comprising: generating an intra prediction in another coding tool which requires an intra prediction signal using the derived IPM.

Clause 89. The method of any of clauses 1-83, wherein the conversion includes encoding the target unit into the bitstream.

Clause 90. The method of any of clauses 1-83, wherein the conversion includes decoding the target unit from the bitstream.

Clause 91. An apparatus for processing video data comprising a processor and a non-transitory memory with instructions thereon, wherein the instructions upon execution by the processor, cause the processor to perform a method in accordance with any of clauses 1-90.

Clause 92. A non-transitory computer-readable storage medium storing instructions that cause a processor to perform a method in accordance with any of clauses 1-90.

Clause 93. A non-transitory computer-readable recording medium storing a bitstream of a video which is generated by a method performed by a video processing apparatus, wherein the method comprises: deriving an intra prediction mode (IPM) for at least one chroma component of a target unit of the video for at least one chroma component, the target unit being applied with a target coding tool; obtaining a prediction for the at least one chroma component of the target unit using the IPM; and generating a bitstream of the target unit based on the prediction.

Clause 94. A method for storing bitstream of a video, comprising: deriving an intra prediction mode (IPM) for at least one chroma component of a target unit of the video, the target unit being applied with a target coding tool; obtaining a prediction for the at least one chroma component of the target unit using the IPM; generating a bitstream of the target unit based on the prediction; and storing the bitstream in a non-transitory computer-readable recording medium.

### Example Device

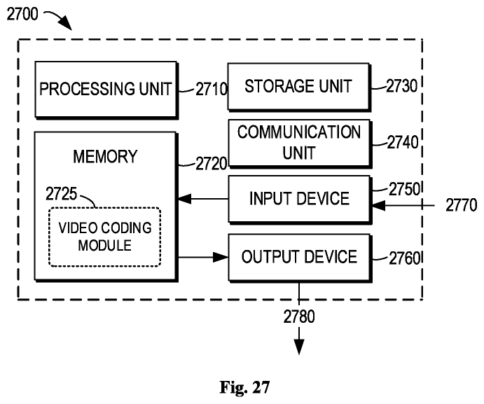

FIG. 27 illustrates a block diagram of a computing device 2700 in which various embodiments of the present disclosure can be implemented. The computing device 2700 may be implemented as or included in the source device 110 (or the video encoder 114 or 200) or the destination device 120 (or the video decoder 124 or 300).

It would be appreciated that the computing device 2700 shown in FIG. 27 is merely for purpose of illustration, without suggesting any limitation to the functions and scopes of the embodiments of the present disclosure in any manner.

As shown in FIG. 27, the computing device 2700 includes a general-purpose computing device 2700. The computing device 2700 may at least comprise one or more processors or processing units 2710, a memory 2720, a storage unit 2730, one or more communication units 2740, one or more input devices 2750, and one or more output devices 2760.

In some embodiments, the computing device 2700 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 2700 can support any type of interface to a user (such as “wearable” circuitry and the like).

The processing unit 2710 may be a physical or virtual processor and can implement various processes based on programs stored in the memory 2720. In a multi-processor system, multiple processing units execute computer executable instructions in parallel so as to improve the parallel processing capability of the computing device 2700. The processing unit 2710 may also be referred to as a central processing unit (CPU), a microprocessor, a controller or a microcontroller.

The computing device 2700 typically includes various computer storage medium. Such medium can be any medium accessible by the computing device 2700, including, but not limited to, volatile and non-volatile medium, or detachable and non-detachable medium. The memory 2720 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 2730 may be any detachable or non-detachable medium and may include a machine-readable medium such as a memory, flash memory drive, magnetic disk or another other media, which can be used for storing information and/or data and can be accessed in the computing device 2700.

The computing device 2700 may further include additional detachable/non-detachable, volatile/non-volatile memory medium. Although not shown in FIG. 27, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 2740 communicates with a further computing device via the communication medium. In addition, the functions of the components in the computing device 2700 can be implemented by a single computing cluster or multiple computing machines that can communicate via communication connections. Therefore, the computing device 2700 can operate in a networked environment using a logical connection with one or more other servers, networked personal computers (PCs) or further general network nodes.

The input device 2750 may be one or more of a variety of input devices, such as a mouse, keyboard, tracking ball, voice-input device, and the like. The output device 2760 may be one or more of a variety of output devices, such as a display, loudspeaker, printer, and the like. By means of the communication unit 2740, the computing device 2700 can further communicate with one or more external devices (not shown) such as the storage devices and display device, with one or more devices enabling the user to interact with the computing device 2700, or any devices (such as a network card, a modem and the like) enabling the computing device 2700 to communicate with one or more other computing devices, if required. Such communication can be performed via input/output (I/O) interfaces (not shown).

In some embodiments, instead of being integrated in a single device, some or all components of the computing device 2700 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 2700 may be used to implement video encoding/decoding in embodiments of the present disclosure. The memory 2720 may include one or more video coding modules 2725 having one or more program instructions. These modules are accessible and executable by the processing unit 2710 to perform the functionalities of the various embodiments described herein.

In the example embodiments of performing video encoding, the input device 2750 may receive video data as an input 2770 to be encoded. The video data may be processed, for example, by the video coding module 2725, to generate an encoded bitstream. The encoded bitstream may be provided via the output device 2760 as an output 2780.

In the example embodiments of performing video decoding, the input device 2750 may receive an encoded bitstream as the input 2770. The encoded bitstream may be processed, for example, by the video coding module 2725, to generate decoded video data. The decoded video data may be provided via the output device 2760 as the output 2780.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method of video processing, comprising:
deriving, during a conversion between a target unit of a video and a bitstream of the target unit, an intra prediction mode (IPM) for at least one chroma component of the target unit, the target unit being applied with a target coding tool;
obtaining a prediction for the at least one chroma component of the target unit using the IPM; and
performing the conversion based on the prediction,
wherein a fusion of predicted signals which are generated by a plurality of IPMs is used as a final prediction for chroma components of the target unit, and
wherein whether to fuse the predicted signals is one of:
indicated in the bitstream,
determined on-the-fly, or
dependent on coding information.

2. The method of claim 1, wherein the target coding tool derives the intra prediction mode using previously decoded blocks or decoded samples, and wherein the target coding tool comprises one of:
a decoder-side derivation of intra prediction mode (DDIPM),
a decoder-side intra mode derivation (DIMD) method, or
a templated based intra prediction mode (TIMD) method, or
wherein a template used to derive the IPM comprises at least one of:
a first set of neighboring adjacent reconstructed samples,
a second set of neighboring adjacent reconstructed pixels,
a third set of neighboring non-adjacent reconstructed samples, or
a fourth set of neighboring non-adjacent reconstructed pixels.

3. The method of claim 2, wherein the template comprises a set of samples of a first component, and the template is used to derive the IPM for the first component, or
wherein the template comprises a set of samples of a first component, and the template is used to derive the IPM for a second component.

4. The method of claim 3, wherein the first component is one of Cb or Cr, or
wherein the first component is Cb and the second component is Cr, or
wherein the first component is Y and the second components are Ch and Cr, or
wherein the first component is Y and the second component is Cb, or
wherein the first component is Y and the second component is Cr.

5. The method of claim 1, wherein during a derivation of the IPM for the at least one chroma component, an intra prediction is processed on a first template using one of IPMs from a first IPM candidate list, and
a candidate IPM with a minimum cost is derived as the IPM for the at least one chroma component.

6. The method of claim 5, wherein the first IPM candidate list for the derivation of the IPM for the at least one chroma component is different from a second IPM candidate list for a derivation of an IPM for a luma component, or
wherein a first target IPM from the first IPM candidate list is derived in a different way as deriving a second target IPM for a luma component, or
wherein a sum of an absolute transformed difference (SATD) between predicted samples and reconstructed samples of the first template is calculated and used to derive a cost associated with the target unit, or
wherein at least one of the followings is calculated and used to derive a cost associated with the target unit:
a sum of squared errors (SSE) between predicted samples of the first template and reconstructed samples of the first template,
a sum of absolute difference (SAD) between the predicted samples of the first template and the reconstructed samples of the first template,
a mean removal sum of absolute difference (MRSAD) between the predicted samples of the first template and the reconstructed samples of the first template,
a subjective quality metric between the predicted samples of the first template and the reconstructed samples of the first template, or
a structural similarity index measure (SSIM) between the predicted samples of the first template and the reconstructed samples of the first template, or
wherein reference samples used in an intra prediction for the first template during the derivation of the IPM for the at least one chroma component are unfiltered.

7. The method of claim 6, wherein the first IPM candidate list comprises one or more cross-component prediction modes, or
wherein an early termination approach is used during the derivation of the IPM for the at least one chroma component.

8. The method of claim 1, wherein a histogram of gradients (HoG) is built using samples/pixels in a first template used to derive the IPM, each bin in the HoG is mapped to one IPM, and
a candidate IPM with a highest amplitude is used as the IPM for the at least one chroma component.

9. The method of claim 8, wherein a derivation of the IPM for the at least one chroma component is same as a derivation of an IPM for a luma component, or
wherein a parameter associated with the first template is different from a parameter associated with a second template used in calculating gradients for a luma component, or
wherein a first ratio of template size for chroma compared to luma follows a second ratio due to colour formats, or
wherein a calculation of gradients for chroma is different from a calculation of gradients for luma, or
wherein the number of bins in the HoG is equal to the number of IPMs that is explicitly indicated, or
wherein the number of bins in the HoG is less than the number of IPMs that is explicitly indicated, or
wherein both chroma components are used to calculate gradients for chroma.

10. The method of claim 9, wherein the parameter associated with the first template comprises at least one of:
a template shape,
a template size, or
a template dimension, or
wherein one of the followings is used for the calculation of gradients for chroma:
a Sobel operator,
an Isotropic Sobel operator,
a Roberts operator,
a Prewitt operator,
a Laplacian operator, or
a Canny operator.

11. The method of claim 1, wherein a target IPM is derived for each chroma component individually, or
wherein the plurality of IPMs comprises at least one of: one or more derived IPMs, one or more predefined prediction modes, or one or more indicated prediction modes.

12. The method of claim 11, wherein the one or more predefined prediction modes comprise a cross-component prediction mode, or
wherein the one or more indicated prediction modes comprise a cross-component prediction mode, or
wherein the one or more predefined prediction modes comprise at least one of:
a planar mode,
a direct currency (DC) mode,
a horizontal mode,
a vertical mode,
a diagonal mode, or
a vertical diagonal mode, or
wherein the one or more indicated prediction modes comprise at least one of:
a planar mode,
a direct currency (DC) mode,
a horizontal mode,
a vertical mode,
a diagonal mode, or
a vertical diagonal mode.

13. The method of claim 1, wherein different approaches for the fusion are used, and
wherein the different approaches comprise at least one of: different IPMs in the fusion, or different weighted factors in the fusion.

14. The method of claim 13, wherein weighted factors are dependent on a cost or amplitude during a derivation of the plurality of IPMs.

15. The method of claim 1, wherein how to fuse the predicted signals is one of:
indicated in the bitstream,
determined on-the-fly, or
dependent on coding information, or
wherein the number of IPMs used in the fusion of the predicted signals is one of:
indicated in the bitstream,
determined on-the-fly, or
dependent on coding information, or
wherein an indication of a method for the fusion of the predicted signals is one of:
indicated in the bitstream,
determined on-the-fly, or
dependent on coding information.

16. The method of claim 1, wherein the conversion includes encoding the target unit into the bitstream.

17. The method of claim 1, wherein the conversion includes decoding the target unit from the bitstream.

18. The method of claim 1, wherein the conversion comprises: generating the bitstream from the target unit, and
the method further comprises: storing the bitstream in a non-transitory computer-readable recording medium.

19. An apparatus for processing video data comprising a processor and a non-transitory memory with instructions thereon, wherein the instructions upon execution by the processor, cause the processor to:
derive, during a conversion between a target unit of a video and a bitstream of the target unit, an intra prediction mode (IPM) for at least one chroma component of the target unit, the target unit being applied with a target coding tool;
obtain a prediction for the at least one chroma component of the target unit using the IPM; and
perform the conversion based on the prediction,
wherein a fusion of predicted signals which are generated by a plurality of IPMs is used as a final prediction for chroma components of the target unit, and
wherein whether to fuse the predicted signals is one of:
indicated in the bitstream,
determined on-the-fly, or
dependent on coding information.

20. A non-transitory computer-readable storage medium storing instructions that cause a processor to:
derive, during a conversion between a target unit of a video and a bitstream of the target unit, an intra prediction mode (IPM) for at least one chroma component of the target unit, the target unit being applied with a target coding tool;
obtain a prediction for the at least one chroma component of the target unit using the IPM; and
perform the conversion based on the prediction,
wherein a fusion of predicted signals which are generated by a plurality of IPMs is used as a final prediction for chroma components of the target unit, and
wherein whether to fuse the predicted signals is one of:
indicated in the bitstream,
determined on-the-fly, or
dependent on coding information.
